(19) United States
(12) Patent Application Publication
(10) Pub. No.: US 2009/0313366 A1
(43) Pub. Date: Dec. 17, 2009

(54) QOS-FOR-EACH-LINE CONTROLLING COMMUNICATION CONTROL APPARATUS, COMMUNICATION SYSTEM AND CONTROL METHOD THEREFOR

(76) Inventors: Hitomi Nakamura, Kokubunji (JP); Masashi Yano, Kawasaki (JP); Junichi Fujiwara, Fujisawa (JP); Toru Matsukawa, Yamato (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/375,595

(22) PCT Filed: Apr. 20, 2007
(86) PCT No.: PCT/JP2007/059129

§ 371 Date: Jan. 29, 2009

(30) Foreign Application Priority Data
Aug. 1, 2006 (JP) 2006-209570

(51) Int. Cl. G06F 15/173; G06F 15/16

(52) U.S. Cl. 709/223; 709/228

(57) ABSTRACT

When receiving a session control signal from a terminal (12), a terminal accommodating apparatus (11) disposed for each line adds the identifier of an access line to the received session control signal and then transmits the resultant signal to a session control server (3). The session control server (3) transmits the access line identifier to a QoS control server (5). The QoS control server (5) performs a QoS control based on a band requested in the session associated with the identifier of the same access line.

### TECHNICAL FIELD

A technology disclosed in this description relates to a communication system that controls a QoS of an access network in association with service control.

### BACKGROUND ART

In recent years, there is an active movement for establishing a next generation backbone IP network called Next Generation Network (NGN) among communication carriers. Conventionally, the communication carriers individually establish networks according to access types such as mobile and fixed and service types such as telephone, broadcast, and the Internet. However, in the NGN, all the networks are integrated on a common IP network.

The standardization of the NGN is performed by the project Telecommunications and Internet converged Services and Protocols For Advanced Networking (TISPAN) of European Telecommunications Standards Institute (ETSI), a standardization organization in Europe, and the project Focus Group Next Generation Network (FGNGN) of the International Telecommunication Union-Telecommunication Standardization (ITU-T). Both the organizations discuss a packet transfer function and a service control function separately. Concerning service control, at present, an IP telephone, a TV conference, and the like are main discussion targets. It has been determined that Session Initiation Protocol (SIP) (IETF RFC3261)/Session Description Protocol (SDP) (IETF RFC2327) is adopted as a protocol.

The discussion is carried forward to conform a configuration of a service network by the SIP to IP Multimedia Subsystem (IMS)/Multimedia Domain (MMD) decided by 3rd Generation Partnership Project (3GPP)/3rd Generation Partnership Project 2 (3GPP2), which is a standardization organization for the third generation mobile communication.

The IMS/MMD specifies, in addition to a normal session control procedure, an access network QoS control procedure (SBBC: Service Based Bearer Control) associated with session control. In the SBBC, a QoS Policy Server is set between an SIP Server and an Access Gateway (AGW). The QoS Policy Server controls QoS setting of the AGW based on service information notified from the SIP Server.

A session establishing procedure in carrying out the SBBC will be described below. First, a calling terminal x exchanges media communication information (IP Address, Port, CODEC, bandwidth in use, etc.) with a called terminal y using SIP/SDP. The SIP Server extracts a filter for identifying a media flow (IP Address, Protocol, and Port), a bandwidth in use, and a terminal ID from a relayed SIP/SDP message and notifies the QoS Policy Server of the same (these kinds of information are hereinafter referred to as service information).

Next, the terminal x requests the AGW to set QoS using RSVP. The QoS setting request includes a flow filter (IP Address, Protocol, and Port), a requested bandwidth, and a terminal ID. The AGW transmits a QoS permission request to the QoS Policy Server in response to the QoS setting request. The QoS Policy Server retrieves service information corresponding to the QoS permission request using the flow filter and the terminal ID as comparison keys. When a bandwidth of the service information is larger than the bandwidth requested from the terminal, the QoS Policy Server permits QoS setting and notifies the AGW to that effect. The AGW sets a flow filter and a bandwidth in a local QoS parameter table in response to the QoS setting permission and returns an acknowledgment to the terminal x. The terminal x notifies the terminal y of the success of QoS setting using the SIP/SDP and completes the session establishment.

### DISCLOSURE OF THE INVENTION

The QoS control procedure is standardized by mainly assuming a mobile network. However, in the NGN, it is anticipated that the same architecture is introduced in a fixed network as well in the future in order to establish an access-independent service network.

In a mobile access network, a QoS resource is secured for each of terminals. On the other hand, in a fixed access network, a QoS resource is secured for each of lines (homes) and a plurality of terminals share a line resource. Therefore, the QoS Policy Server needs to execute QoS permission taking into account a bandwidth used for each of the lines and constraints (guaranteed bandwidth of the line, etc.) imposed on the line. However, in the QoS control procedure described above, information for identifying the line is not included in both the SIP and QoS setting requests. Therefore, there is a problem in that the QoS Policy Server cannot calculate a total of bandwidths used for each of the lines (first problem).

In the mobile access network, terminal authentication is executed when a terminal makes connection to the access network. Therefore, only a terminal having a relation of trust with a communication carrier can transmit the QoS setting request to the AGW. On the other hand, in the fixed access network, a terminal is accommodated in a home network and makes connection to an access network of a communication carrier via a communication apparatus such as a Home Gateway (HGW). The communication carrier executes authentication of the HGW but does not execute authentication of the terminal. Therefore, like the mobile access network, when the architecture in which the QoS setting request is transmitted from the terminal is adopted, there is a security problem because a terminal not having a relation of trust with the communication carrier controls the QoS setting for the AGW (second problem).

A representative example of this invention is as follows. That is, there is provided a communication system, comprising: a plurality of terminals connected to a communication network via an access line; a session control server that processes a session control signal transmitted from the terminals; and a QoS control server that controls a QoS of the access line, wherein: the terminals transmit at least the session control signal containing information indicating a bandwidth requested by the terminals in a session to the session control server; the terminals further transmit an identifier of the access line to the session control server; the session control server transmits the received identifier of the access line and the information indicating the bandwidth requested by the terminals in the session to the QoS control server; and the QoS control server controls the QoS based on a bandwidth requested in a session associated with the same identifier of the access line.

According to embodiments of this invention, it is possible to control QoS for each of lines.

According to the embodiments of this invention, it is possible to configure a system in which only an apparatus having a relation of trust with a communication carrier controls the QoS setting for the AGW.

### BRIEF DESCRIPTION OF THE DRAWINGS

FIG. 1 is an explanatory diagram illustrating a configuration example of a communication network according to a first embodiment of this invention.

FIG. 2A is a block diagram illustrating a configuration of a SIP Server according to the first embodiment of this invention.

FIG. 2B is an explanatory diagram of a SIP Session Table stored by the SIP Server according to the first embodiment of this invention.

FIG. 3A is a block diagram illustrating a configuration of a QoS Policy Server according to the first embodiment of this invention.

FIG. 3B is an explanatory diagram of a Service Information Table stored by the QoS Policy Server according to the first embodiment of this invention.

FIG. 3C is an explanatory diagram of a Flow Table stored by the QoS Policy Server according to the first embodiment of this invention.

FIG. 3D is an explanatory diagram of a Line Table stored by the QoS Policy Server according to the first embodiment of this invention. FIG. 4A is a block diagram illustrating a configuration of a HGW according to the first embodiment of this invention.

FIG. 4B is an explanatory diagram of a SIP Session Table stored by the HGW according to the first embodiment of this invention.

FIG. 4C is an explanatory diagram of a Flow Table stored by the HGW according to the first embodiment of this invention.

FIG. 4D is an explanatory diagram of a RSVP Session Table stored by the HGW according to the first embodiment of this invention.

FIG. 5 is a sequence chart illustrating processing for session establishment according to the first embodiment of this invention.

FIG. 6 is an explanatory diagram illustrating an example of a SIP INVITE to which a Line-ID is added by the HGW according to the first embodiment of this invention.

FIGS. 7A and 7B are explanatory diagrams of packet formats of a RSVP Resv transmitted in the first embodiment of this invention.

FIG. 8 is a flowchart illustrating Line-ID addition determination processing executed by the HGW according to the first embodiment of this invention.

FIG. 9 is a flowchart illustrating service information notification processing executed by the SIP Server according to the first embodiment of this invention.

FIG. 10 is a flowchart illustrating Flow registration/RSVP Resv transmission processing executed by the HGW according to the first embodiment of this invention.

FIG. 11 is a flowchart illustrating RSVP Resv reception processing executed by the HGW according to the first embodiment of this invention.

FIG. 12 is a flowchart illustrating Flow permission processing executed by the QoS Policy Server according to the first embodiment of this invention.

FIG. 13 is a flowchart illustrating RSVP ResvConf reception processing executed by the HGW according to the first embodiment of this invention.

FIG. 14 is a sequence chart illustrating processing for session disconnection according to the first embodiment of this invention.

FIG. 15 is a flowchart illustrating service information/Flow permission deletion processing executed by the QoS Policy Server according to the first embodiment of this invention.

FIG. 16A is an explanatory diagram of a Registration Table stored by a SIP server according to a second embodiment of this invention.

FIG. 16B is an explanatory diagram of a SIP Session Table stored by the SIP Server according to the second embodiment of this invention.

FIG. 17 is a sequence chart illustrating processing for session establishment according to the second embodiment of this invention.

FIG. 18 is a flowchart illustrating Line-ID addition determination processing executed by a HGW according to the second embodiment of this invention.

FIG. 19 is a flowchart illustrating service information notification processing executed by the SIP Server according to the second embodiment of this invention.

FIG. 20 is an explanatory diagram illustrating a configuration example of a communication network according to a third embodiment of this invention.

FIG. 21A is a block diagram illustrating a configuration of a QoS Policy Server according to the third embodiment of this invention.

FIG. 21B is an explanatory diagram of a Service Information Table stored by the QoS Policy Server according to the third embodiment of this invention.

FIG. 21C is an explanatory diagram of a Line table stored by the QoS Policy Server according to the third embodiment of this invention.

FIGS. 22A and 22B are sequence charts illustrating processing for session establishment according to the third embodiment of this invention.

FIG. 23 is a flowchart for illustrating service permission processing executed by the QoS Policy Server according to the third embodiment of this invention.

FIG. 24 is a sequence chart illustrating processing executed for session disconnection according to the third embodiment of this invention.

FIG. 25 is a flowchart for illustrating service permission deletion processing executed by the QoS Policy Server according to the third embodiment of this invention.

### BEST MODES FOR CARRYING OUT THE INVENTION

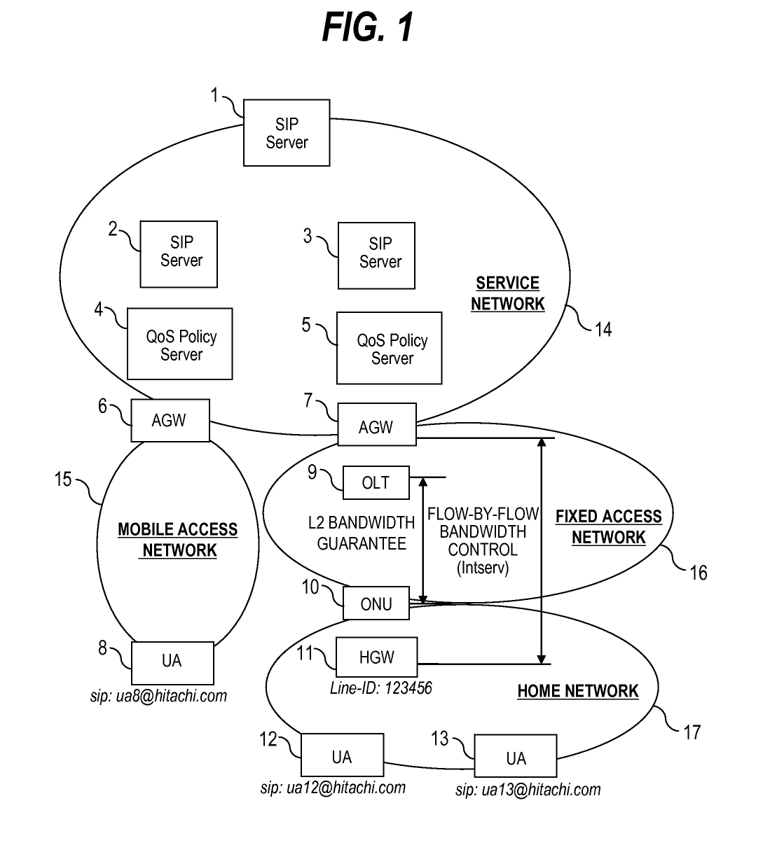

FIG. 1 is an explanatory diagram illustrating a configuration example of a communication network according to a first embodiment of this invention.

The communication network illustrated in FIG. 1 includes an access-independent service network 14, a mobile access network 15, a fixed access network 16, and a home network 17. The home network 17 is connected to the fixed access network 16.

The service network 14 includes SIP Servers (1, 2, and 3), QoS Policy Servers (4 and 5), and AGWs (6 and 7). The SIP Server 1 operates as an SIP Registrar and a Proxy and performs location management and service control for terminals. The SIP Servers 2 and 3 operate as SIP Proxies and accommodate terminals of the mobile access network 15 and the fixed access network 16, respectively. In IMS/MMD, the SIP Server 1 is referred to as Serving Call Session Control Function (S-CSCF) and the SIP Servers (2 and 3) are referred to as Proxy Call Session Control Function (P-CSCF).

The QoS Policy Servers (4 and 5) control quality of service (QoS) setting for the AGWs (6 and 7) based on service information notified from the SIP Servers (2 and 3).

The AGWs (6 and 7) are respectively set in a boundary between the mobile access network 15 and the service network 14 and a boundary between the fixed access network 16 and the service network 14 and accommodate terminals of the respective access networks.

The mobile access network 15 accommodates a User Agent (UA) 8. In the UA 8, an SIP URI (sip:ua8@hitachi.com) is set.

The fixed access network 16 uses a Passive Optical Network (PON) as an access facility and includes an Optical Line Terminal (OLT) 9 and an Optical Network Unit (ONU) 10.

The home network 17 includes an HGW 11 and UAs (12 and 13). In the HGW 11, an ID (Line-ID: 123456) for identifying a line is set. In the UAs (12 and 13), SIP URIs (sip:ua12@hitachi.com and sip:ua13@hitachi.com) are set.

In the fixed access network 16, QoS processing described below is performed. The AGW 7 and the HGW 11 perform flow-by-flow bandwidth guarantee in a Layer 3 and higher layers. The AGW 7 and the HGW 11 identify a priority flow and put markings in a Type of Service (TOS) field of an IPv4 header and a Traffic Class field of an IPv6 header. Filter information and a guaranteed bandwidth for identifying a flow are dynamically set when a session is established.

The OLT 9 and the ONU 10 perform bandwidth guarantee for the priority flow at a level of a Layer 2. The identification of the priority flow is performed according to a result of the marking by the AGW 7 and the HGW 11. The guaranteed bandwidth is controlled by the QoS Policy Server 5 according to necessity.

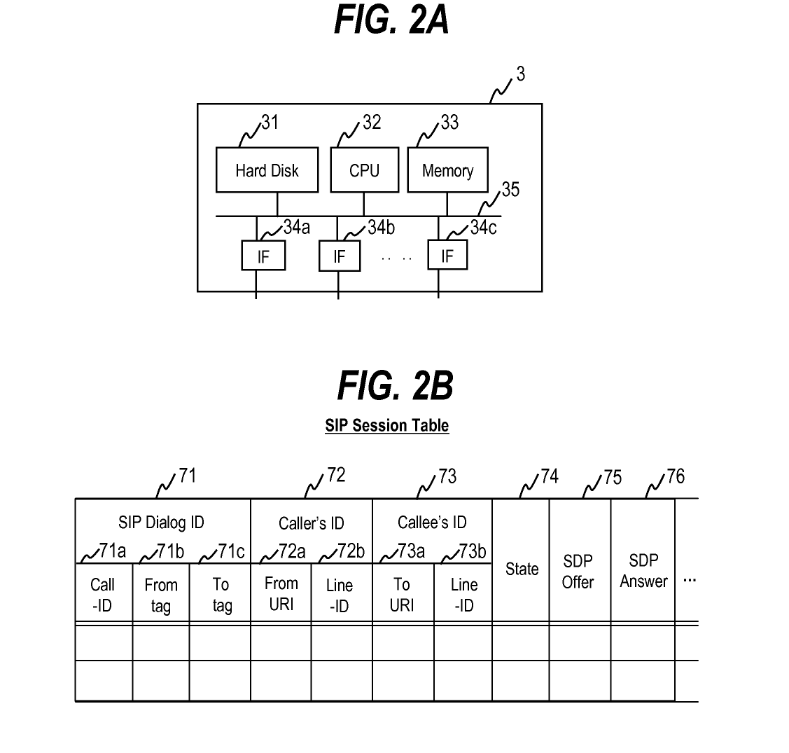

FIG. 2A is a block diagram illustrating a configuration of the SIP Server 3 according to the first embodiment of this invention.

The SIP Server 3 includes a Hard Disk 31, a CPU 32, a Memory 33, IFs (34a, 34b, and 34c), and a bus 35. Processing procedures for the SIP Server 3 are stored in the Memory 33. The CPU 32 sequentially reads out and executes the processing procedures.

The SIP Server 3 stores an SIP Session Table illustrated in FIG. 2B in order to manage an SIP Session. The SIP Session Table is stored in the Hard Disk 31 or the Memory 33.

FIG. 2B is an explanatory diagram of the SIP Session Table stored by the SIP Server 3 according to the first embodiment of this invention. The SIP Session Table (FIG. 2B) includes an SIP Dialog ID 71 for uniquely identifying the SIP Session, a Caller's ID 72 indicating calling terminal information (i.e., information for identifying a terminal on a calling side), a Callee's ID 73 indicating called terminal information (i.e., information for identifying a terminal on a called side), a State 74 indicating a session state, an SDP Offer 75, and an SDP Answer 76.

The SIP Dialog ID 71 includes a Call-ID 71a, a From tag 71b, and a To tag 71c. The Caller's ID 72 includes a From URI 72a and a Line-ID 72b. The Callee's ID 73 includes a To URI 73a and a Line-ID 73b. The SIP Server 3 acquires those parameters when an SIP Message is transferred, and sets the acquired parameters in the SIP Session Table.

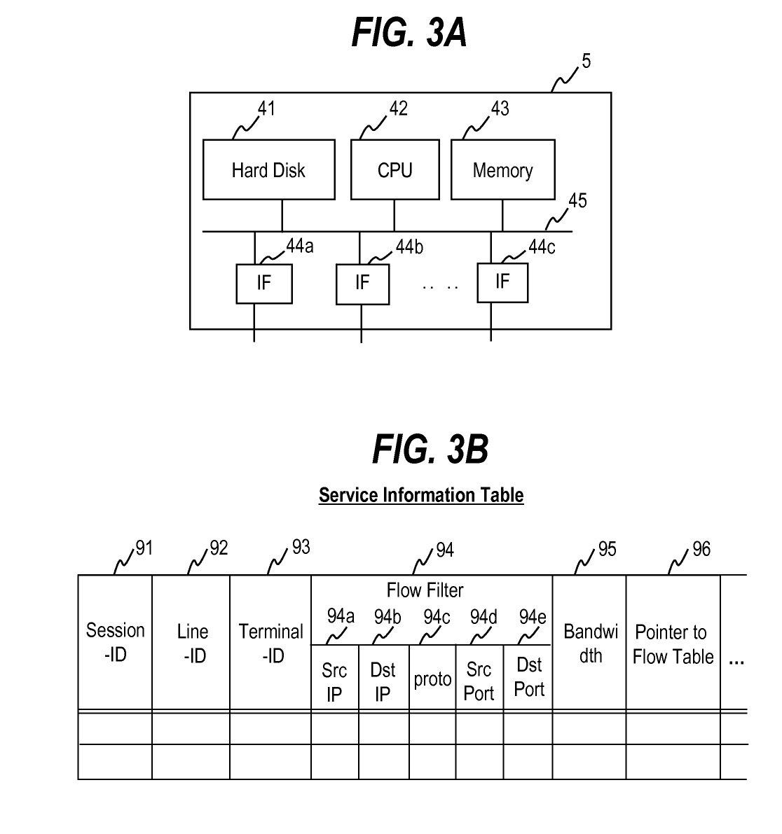

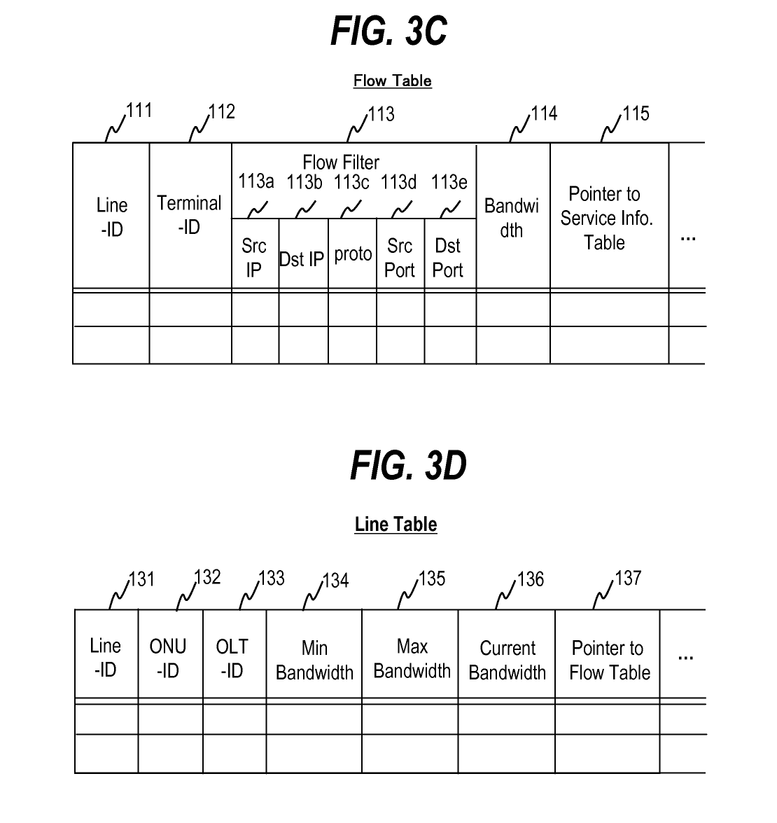

FIG. 3A is a block diagram illustrating a configuration of the QoS Policy Server 5 according to the first embodiment of this invention.

The QoS Policy Server 5 includes a Hard Disk 41, a CPU 42, a Memory 43, IFs (44a, 44b, and 44c), and a bus 45. Processing procedures for the QoS Policy Server 5 are stored in the Memory 43. The CPU 42 sequentially reads out and executes the processing procedures.

The QoS Policy Server 5 stores a Service Information Table illustrated in FIG. 3B, a Flow Table illustrated in FIG. 3C, and a Line Table illustrated in FIG. 3D. Those tables are stored in the Hard Disk 41 or the Memory 43.

FIG. 3B is an explanatory diagram of the Service Information Table stored by the QoS Policy Server 5 according to the first embodiment of this invention.

The Service Information Table (FIG. 3B) is a table for managing service information notified from the SIP Server 3. The Service Information Table (FIG. 3B) includes a Session ID 91 for identifying an SIP Session, a Line-ID 92 for identifying a line, a Terminal-ID 93 for identifying a terminal, a Flow Filter 94 for identifying a flow, a Bandwidth 95 indicating a bandwidth used by the flow, and a Pointer to Flow Table 96 as a pointer to a flow associated with service information (Flow Table illustrated in FIG. 3C).

The Flow Filter 94 includes an Src IP 94a, a Dst IP 94b, a proto 94c, an Src Port 94d, and a Dst Port 94e.

FIG. 3C is an explanatory diagram of the Flow Table stored by the QoS Policy Server 5 according to the first embodiment of this invention.

The Flow Table (FIG. 3C) is a table for managing a flow permitted to the AGW 7. The Flow Table (FIG. 3C) includes a Line-ID 111 for identifying a line, a Terminal-ID 112 for identifying a terminal, a Flow Filter 113 for identifying a flow, a Bandwidth 114 indicating a requested bandwidth, and a Pointer to Service Info. Table 115 as a pointer to service information associated with a flow (Service Information Table illustrated in FIG. 3B).

The Flow Filter 113 includes an Src IP 113a, a Dst IP 113b, a proto 113c, an Src Port 113d, and a Dst Port 113e.

FIG. 3D is an explanatory diagram of the Line Table stored by the QoS Policy Server 5 according to the first embodiment of this invention.

The Line Table (FIG. 3D) is a table for managing a bandwidth of each of lines. The Line Table (FIG. 3D) includes a Line-ID 131 for identifying a line, an ONU-ID 132 for identifying an ONU, an OLT-ID 133 for identifying an OLT, a minimum guaranteed bandwidth Min Bandwidth 134 of the line, a maximum guaranteed bandwidth Max Bandwidth 135, a current bandwidth Current Bandwidth 136, and a Pointer to Flow Table 137 as a pointer to a flow that uses the line (Flow Table illustrated in FIG. 3C). When a plurality of flows that use the line are present, a plurality of pointers are set in the Pointer to Flow Table 137.

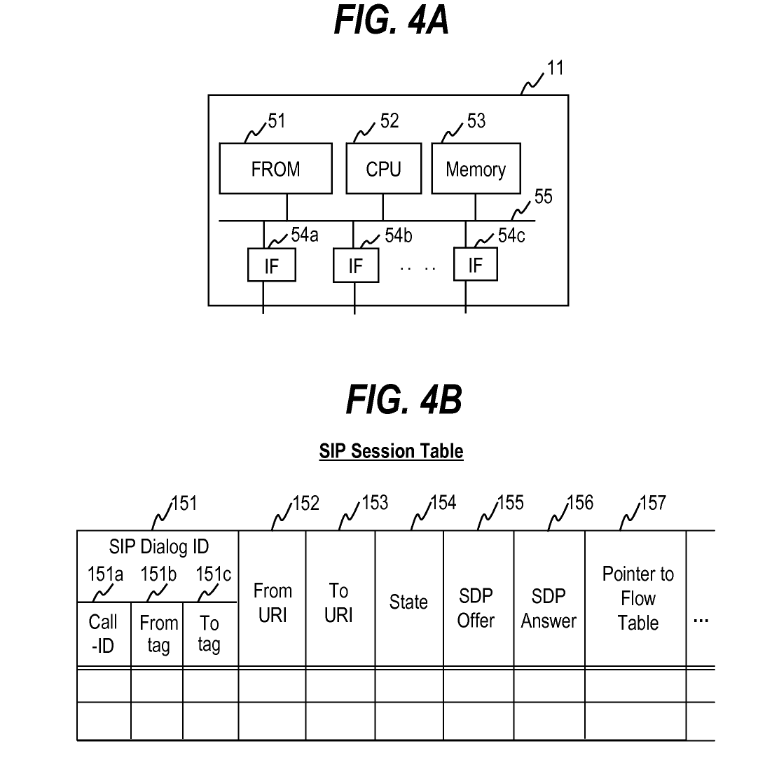

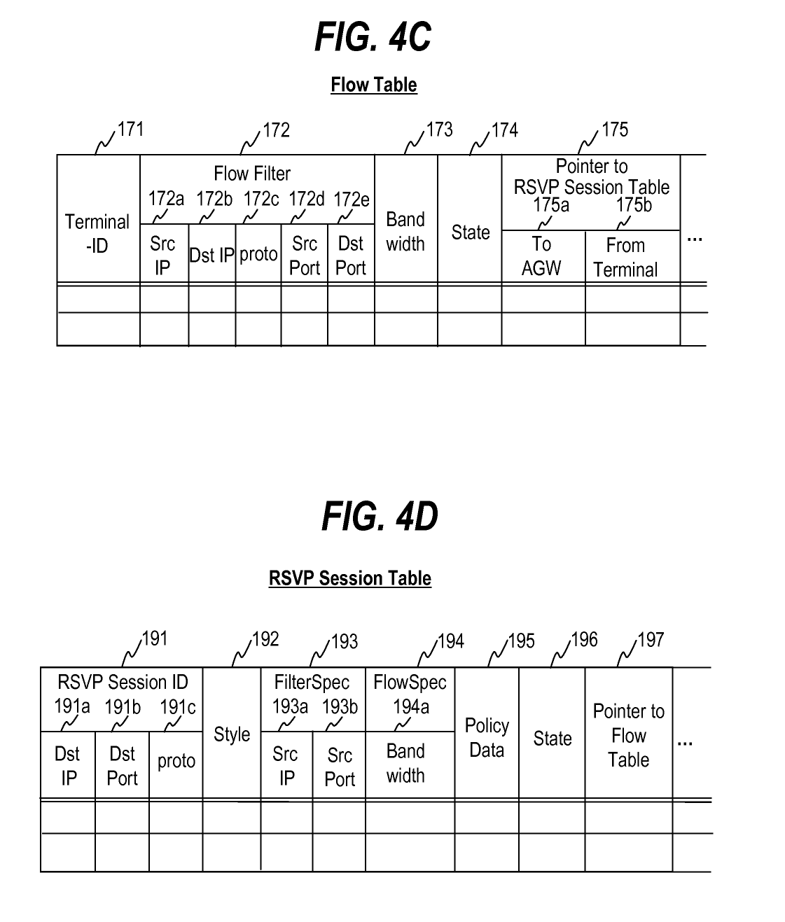

FIG. 4A is a block diagram illustrating a configuration of the HGW 11 according to the first embodiment of this invention.

The HGW 11 includes a Flush ROM (FROM) 51, a CPU 52, a Memory 53, IFs (54a, 54b, and 54c), and a bus 55. Processing procedures for the HGW 11 are stored in the Memory 53. The CPU 52 sequentially reads out and executes the processing procedures.

The HGW 11 stores an SIP Session Table illustrated in FIG. 4B, a Flow Table illustrated in FIG. 4C, and an RSVP Session Table illustrated in FIG. 4D. Those tables are stored in the FROM 51 or the Memory 53.

FIG. 4B is an explanatory diagram of the SIP Session Table stored by the HGW 11 according to the first embodiment of this invention.

The SIP Session Table (FIG. 4B) is a table for managing an SIP session. The SIP Session Table (FIG. 4B) includes an SIP Dialog ID 151 for identifying the SIP Session, a From URI 152 for identifying a calling terminal, a To URI 153 for identifying a called terminal, a State 154 indicating a session state, an SDP Offer 155, an SDP Answer 156, and a Pointer to Flow Table 157 as a pointer to a flow related to the SIP Session (Flow Table illustrated in FIG. 4C). The SIP Dialog ID 151 includes a Call-ID 151a, a From tag 151b, and a To tag 151c.

FIG. 4C is an explanatory diagram of the Flow Table stored by the HGW 11 according to the first embodiment of this invention.

The Flow Table (FIG. 4C) is a table for managing a flow related to an SIP Session. The Flow Table (FIG. 4C) includes a Terminal-ID 171 for identifying a terminal, a Flow Filter 172 for identifying a flow, a Bandwidth 173 indicating a bandwidth of the flow, a State 174 indicating a state of the flow, and a Pointer to RSVP Session Table 175 as a pointer to a RSVP Session associated with the flow (Flow Table illustrated in FIG. 4D).

The Flow Filter 172 includes an Src IP 172a, a Dst IP 172b, a proto 172c, an Src Port 172d, and a Dst Port 172e. The Pointer to RSVP Session Table 175 includes two kinds of fields (i.e., To AGW 175a and From Terminal 175b). Those fields are used for associating “a QoS setting request transmitted by the HGW 11 to the AGW 7” and “a QoS setting request received from a terminal” with a flow.

FIG. 4D is an explanatory diagram of the RSVP Session Table stored by the HGW 11 according to the first embodiment of this invention.

The RSVP Session Table (FIG. 4D) is a table for managing an RSVP session. The RSVP Session Table (FIG. 4D) includes an RSVP Session ID 191 for identifying the RSVP Session, a Style 192 indicating a reservation style, a Filter Spec 193 indicating identification information of a flow, a Flow Spec 194 indicating a flow characteristic, Policy Data 195 used for determination of necessity of QoS setting, a State 196 indicating an RSVP Session state, and a Pointer to Flow Table 197 as a pointer to a flow related to the RSVP Session (Flow Table illustrated in FIG. 4C).

The RSVP Session ID 191 includes a Dst IP 191a, a Dst Port 191b, and a Proto 191c. The Filter Spec 193 includes an Src IP 193a and an Src Port 193b. The Filter Spec 194 includes a Bandwidth 194a. A requester ID and the like are set in the Policy Data 195.

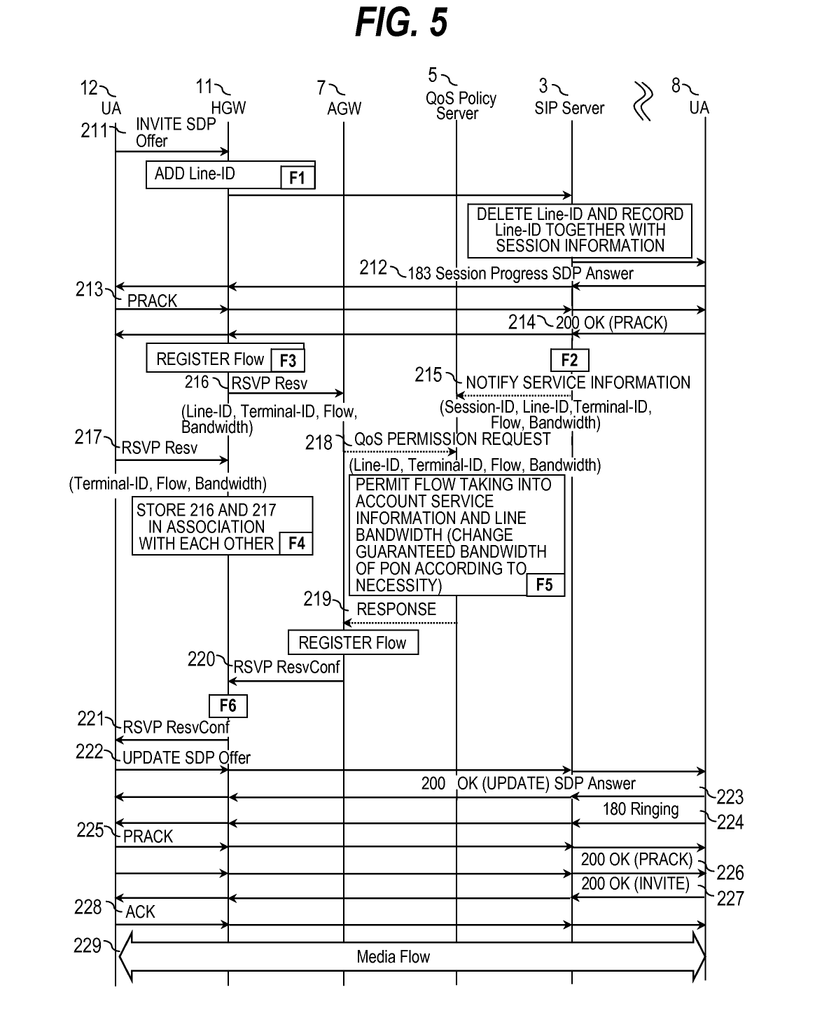

FIG. 5 is a sequence chart illustrating processing for session establishment according to the first embodiment of this invention.

FIG. 5 illustrates, as an example, a sequence for a terminal (UA 12) connected to the home network 17 to establish a session between the terminal (UA12) and a terminal (UA 8) connected to the mobile access network. The terminals (UA 12 and UA 8) correspond to a precondition option specified by IETF RFC3312 and complete QoS resource reservation for an access network before calling a user on a called side. Details of this sequence will be described below.

First, the terminal (UA 12) transmits an SIP INVITE 211 including an SDP Offer to the HGW 11.

The SIP INVITE 211 includes information indicating a bandwidth requested by the terminal (UA 12) in a session about to be established.

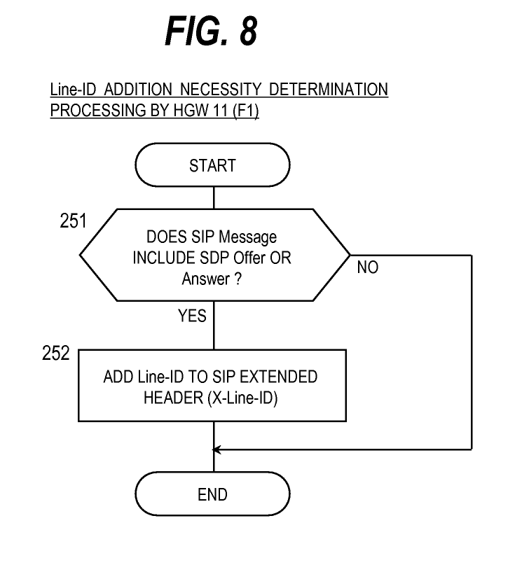

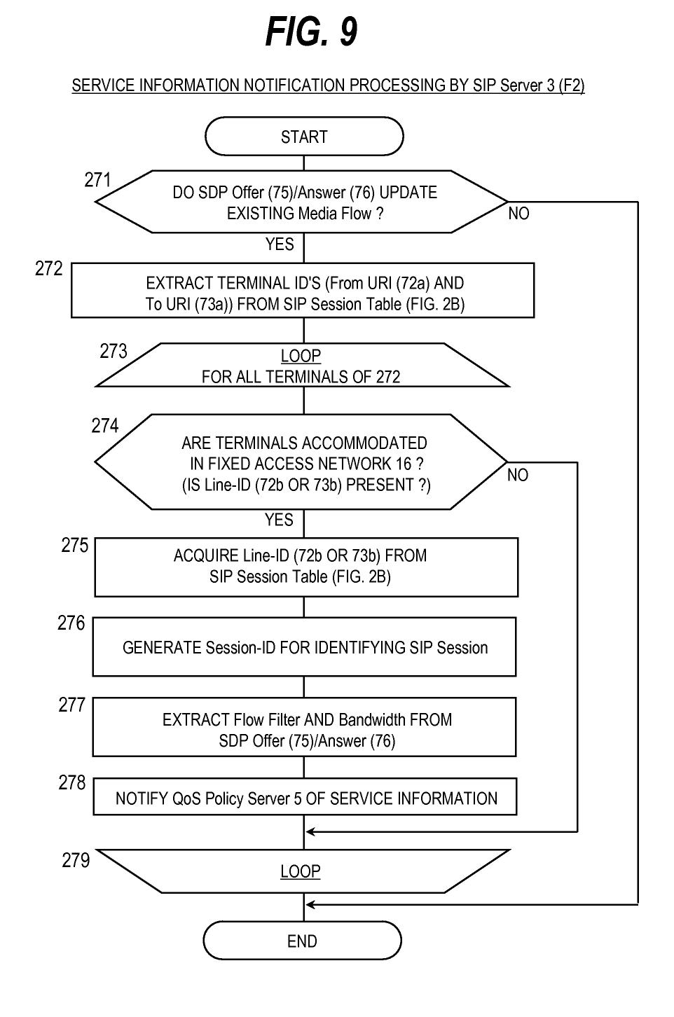

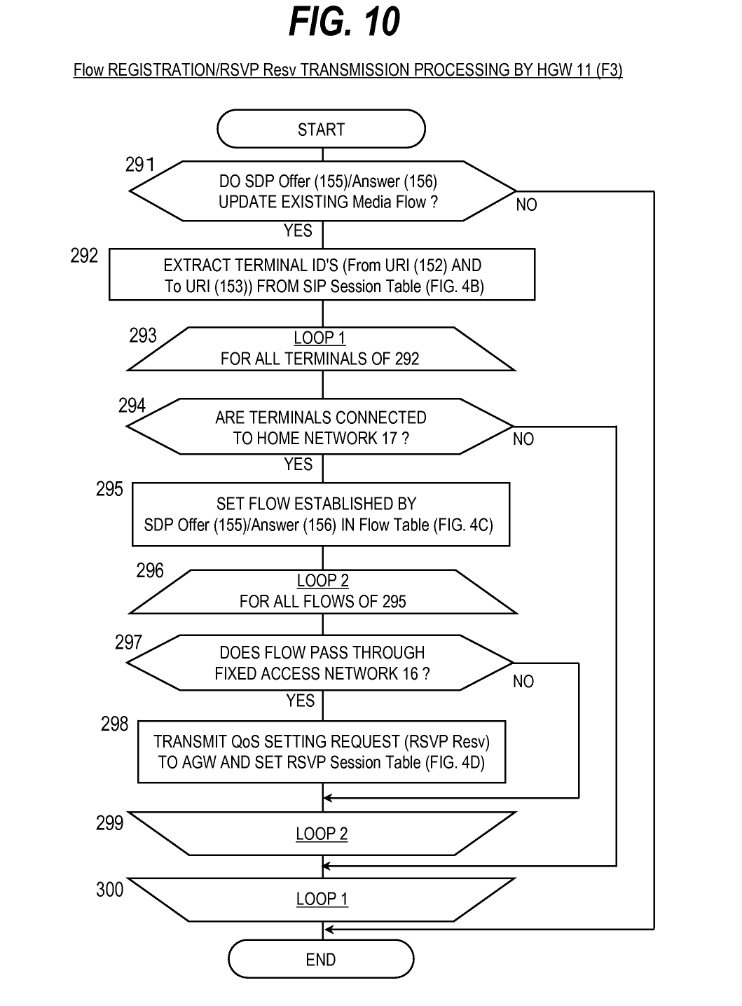

The HGW 11 records Session information in the SIP Session Table (FIG. 4B). Further, the HGW 11 adds a Line-ID to the INVITE 211 and transfers the INVITE 211 to the SIP Server 3 (F1). Processing executed in F1 will be described later in detail (see FIG. 8).

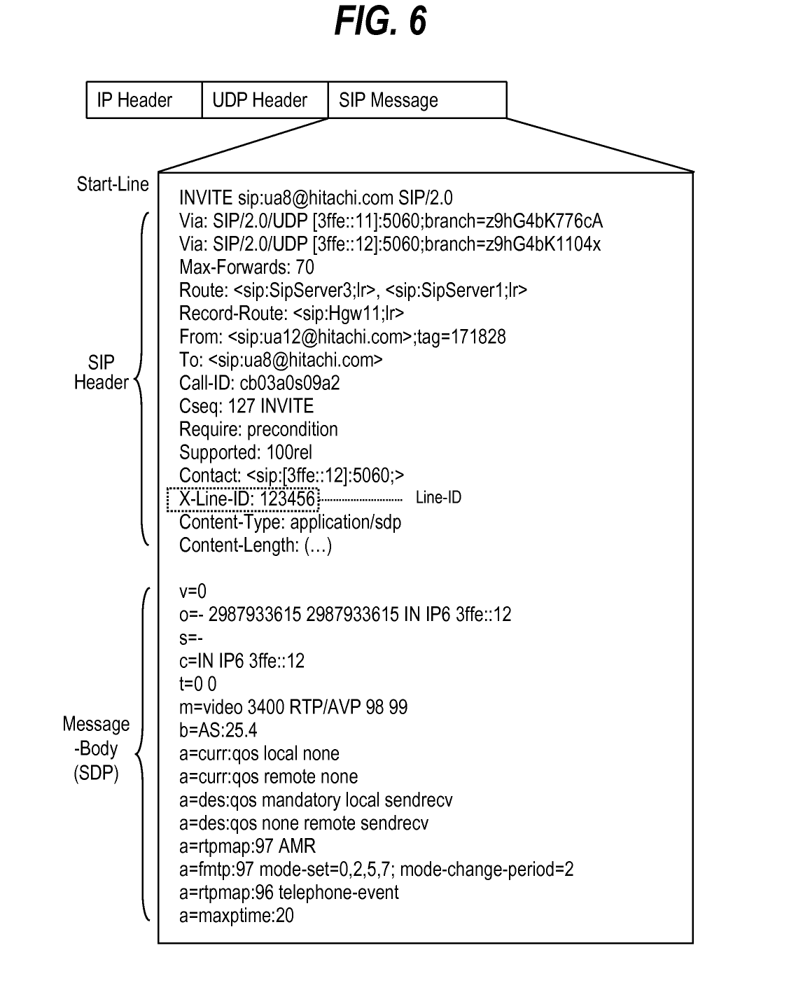

FIG. 6 is an explanatory diagram illustrating an example of the SIP INVITE 211 to which the Line-ID is added by the HGW 11 according to the first embodiment of this invention.

The SIP INVITE includes an IP Header, a UDP Header, and an SIP Message. The SIP Message includes a Start-Line, an SIP Header, and a Message-Body (SDP). In the example illustrated in FIG. 6, a Line-ID “123456” is set in an extended SIP Header (X-Line-ID Header).

The Line-ID “123456” may be set in an SDP attribute row (not shown).

Referring to FIG. 5 again, the description of the sequence is continued.

When the SIP Server 3 receives the INVITE 211 from the HGW 11, the SIP Server 3 deletes a Line-ID from the X-Line-ID Header and records the Line-ID in the SIP Session Table (FIG. 2B) together with Session information.

In this sequence, the Line-ID is set in 72b. Further, the SIP Server 3 transfers the INVITE 211 to the SIP Server 1. The INVITE 211 reaches a terminal (UA 8) through the SIP Server 1 and the SIP Server 2. In FIG. 5, the SIP Servers 1 and 2 are omitted.

The terminal (UA 8) returns an interim response (183 response) 212 including an SDP Answer. The 183 response 212 reaches the terminal (UA 12) through a path opposite to that of the INVITE 211. The terminal (UA 12) transmits a Provisional Response Acknowledgement (PRACK) 213 to the 183 response 212. The terminal (UA 8) returns a 200 response 214 to the PRACK 213.

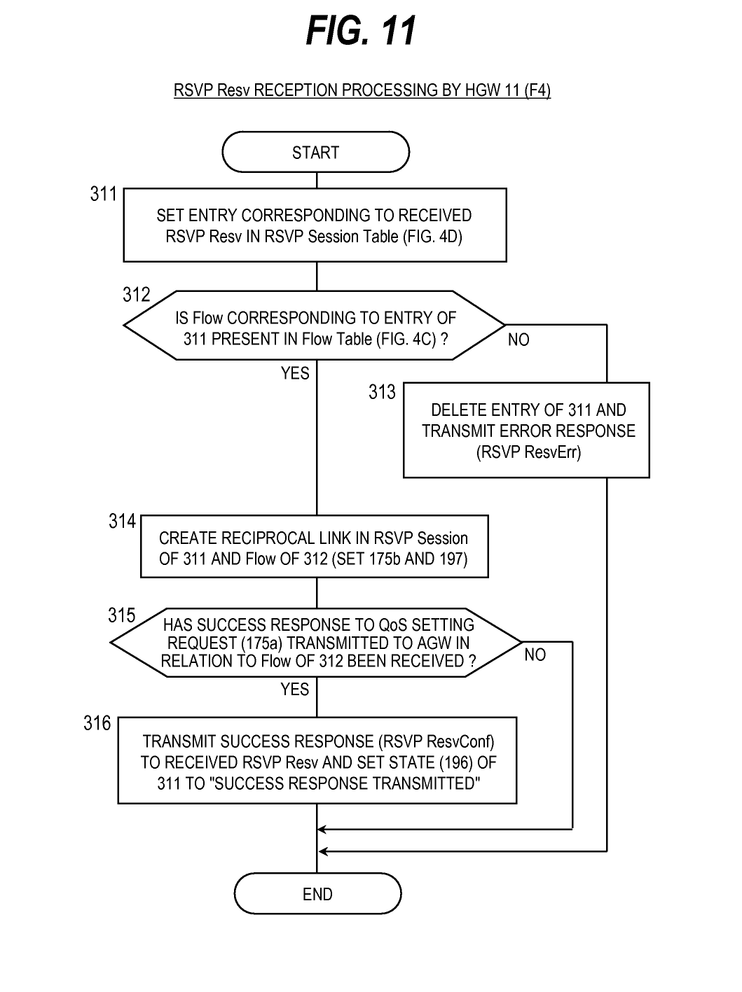

The SIP Server 3 notifies the QoS Policy Server 5 of the service information 215 with the transfer of the 183 response 212 including the SDP Answer as an opportunity (F2). This notification may be transmitted earlier than the PRACK 213 or the 200 response 214. Processing executed in F2 will be described later in detail (see FIG. 9).

A Session-ID for identifying an SIP Session, a Line-ID for identifying a line, a Terminal-ID for identifying a terminal, filter information for identifying a Flow, and a bandwidth are included in the service information 215. Those kinds of information are based on information included in the INVITE 211 and the 183 response 212. The bandwidth included in the service information 215 is a bandwidth that a terminal identified by the Terminal-ID requests in a session. The QoS Policy Server 3 records the notified information in the Service Information Table (FIG. 3B).

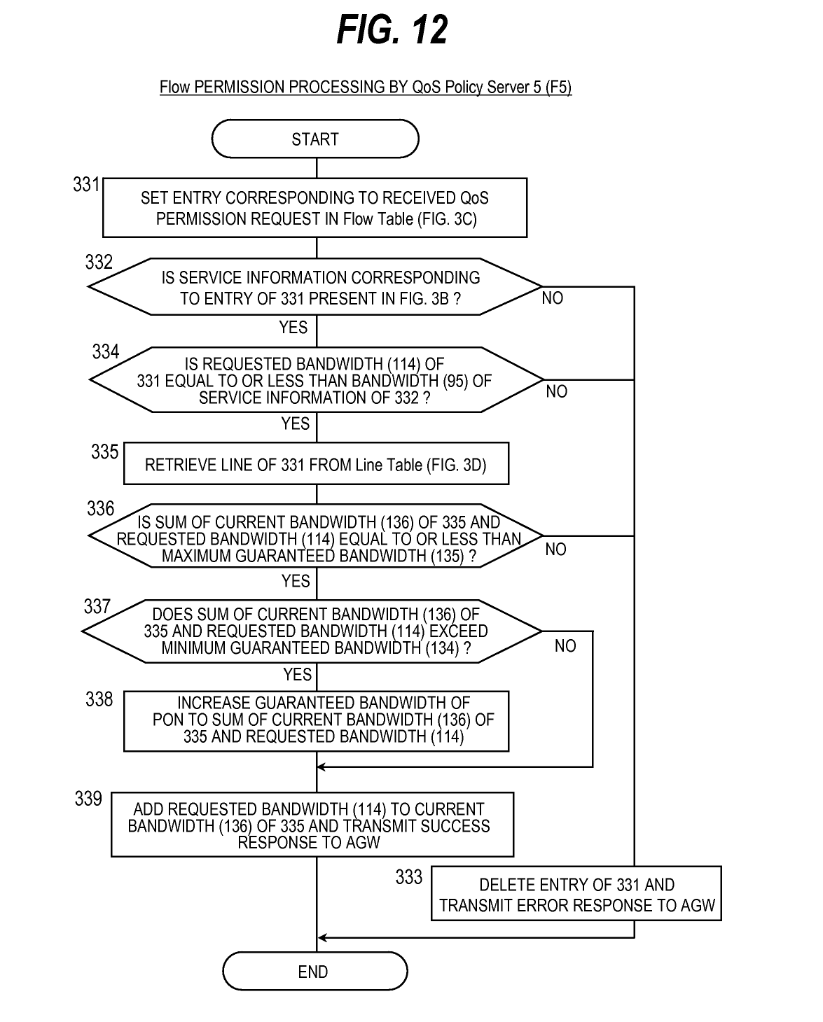

The HGW 11 registers a flow related to the Session in the Flow Table (FIG. 4C) with the transfer of the 183 response 212 including the Answer as an opportunity. Further, the HGW 11 transmits the RSVP Resv 216 to the AGW 7 and requests QoS setting for the fixed access network 16 (F3). This request may be transmitted earlier than the PRACK 213 or the 200 response 214. The processing executed in F3 will be described in detail later (see FIG. 10). A Line-ID, a Terminal-ID, filter information of a Flow, and a requested bandwidth are included in the RSVP Resv 216.

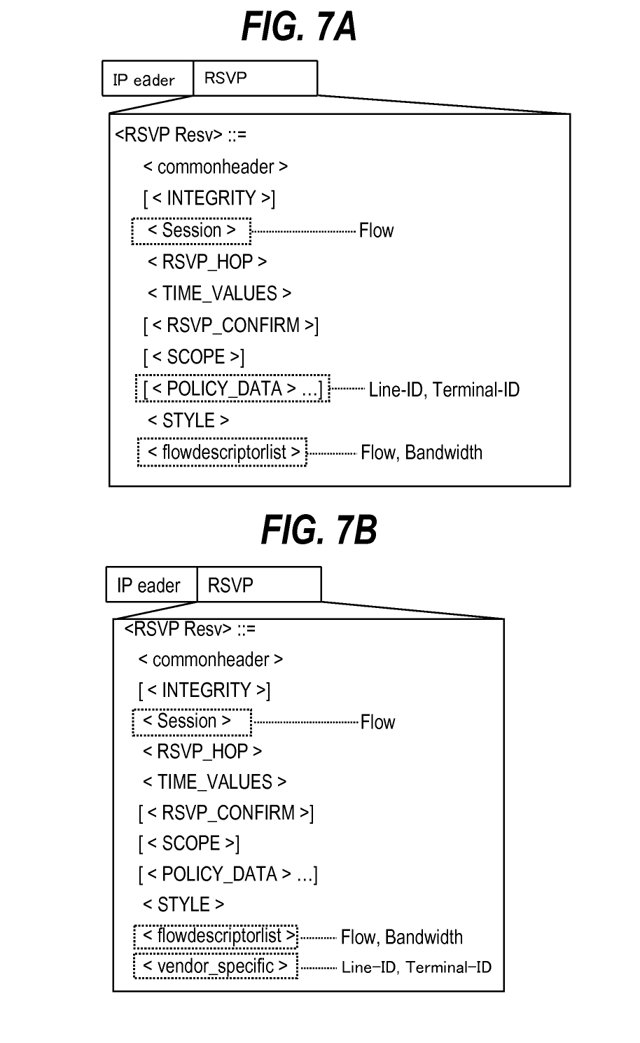

FIGS. 7A and 7B are explanatory diagrams of packet formats of the RSVP Resv 216 transmitted in the first embodiment of this invention.

In an example illustrated in FIG. 7A, filter information and a bandwidth are set in a SESSION object and a flowdescriptorlist object, respectively. Further, a Line-ID and a Terminal-ID are set in a POLICY_DATA object.

In an example illustrated in FIG. 7B, a Line-ID and a Terminal-ID are set in a vender extension (vendor specific) region.

In this embodiment, any one of the formats illustrated in FIGS. 7A and 7B may be applied.

Referring to FIG. 5 again, the description of the sequence is continued.

The terminal (UA 12) transmits an RSVP Resv 217 and requests QoS setting for the home network 17 with the reception of the 200 response 214 to the PRACK as an opportunity. A Terminal-ID, filter information of a Flow, and a requested bandwidth are included in the RSVP Resv 217. The HGW 11 manages the RSVP Resv 216 and the RSVP Resv 217 in association with each other using the Terminal-ID and the filter information as comparison keys (F4). Processing executed in F4 will be described in detail later (see FIG. 11).

The AGW 7 transmits a QoS permission request 218 to the QoS Policy Server 5 with the reception of the RSVP Resv 216 from the HGW 11 as an opportunity. The QoS permission request 218 designates the Line-ID, the Terminal-ID, the filter information, and the bandwidth which are included in the RSVP Resv 216. In other words, the information such as the Line-ID and the bandwidth which are included in the QoS control signal (RSVP Resv 216) transmitted from the HGW 11 finally reaches the QoS Policy Server 5.

The QoS Policy Server 5 permits QoS setting taking into account the service information 215 notified from the SIP Server 3 and a line bandwidth. Further, the QoS Policy Server 5 controls a line guaranteed bandwidth of PON according to necessity and returns a success response 219 to the AGW 7 (F5). Processing executed in F5 will be described in detail later (see FIG. 12).

When the AGW 7 receives the response 219, the AGW 7 sets QoS parameters designated by the RSVP Resv 216 in a local table (not shown) and transmits an RSVP ResvConf 220.

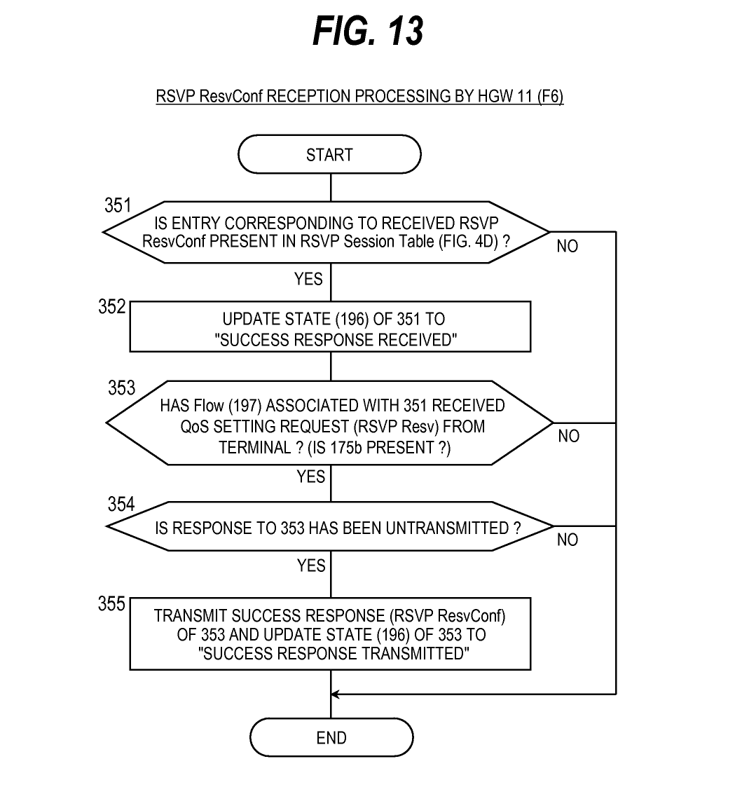

When the HGW 11 receives the RSVP ResvConf 220, the HGW 11 transmits an RSVP ResvConf 221 to the RSVP Resv 217 to the terminal (UA 12) (F6). Processing executed in F6 will be described in detail later (see FIG. 13).

According to the procedure described above, the QoS setting for the fixed access network 16 and the home network 17 is completed.

Thereafter, the terminal (UA 12) transmits an SIP UPDATE 222 including an SDP Offer and notifies the terminal (UA 8) of the completion of the QoS setting. The terminal (UA 8) returns a 200 response 223 including an SDP Answer. Further, the terminal (UA 8) starts a user call and transmits a 180 response 224. The terminal (UA 12) transmits a PRACK 225 to the 180 response 224. The terminal (UA 8) transmits a 200 response 226 to the PRACK 225.

The terminal (UA 8) transmits a 200 response 227 to the INVITE 211 with off-hook of a called user as an opportunity. The terminal (UA 12) returns an ACK 228. According to the procedure described above, the session establishment is completed, and transmission and reception of a Media Flow 229 is started.

In relation to the sequence illustrated in FIG. 5, processing characteristic of this invention (specifically, processing executed in F1 to F6 of FIG. 5) will be described below.

FIG. 8 is a flowchart illustrating Line-ID addition determination processing (F1 of FIG. 5) executed by the HGW 11 according to the first embodiment of this invention.

For processing efficiency, the HGW 11 selectively adds a Line-ID according to an SIP message type and a content of a message body.

First, the HGW 11 determines whether or not an SDP Offer or an SDP Answer is included in the SIP Message (251).

When neither the SDP Offer nor the SDP Answer is included in the SIP Message, the HGW 11 finishes the processing without adding the Line-ID to the SIP Message. On the other hand, any one of the SDP Offer and the SDP Answer is included in the SIP Message, the HGW 11 adds the Line-ID to the SIP Message (252) and finishes the processing.

According to the execution of the processing illustrated in FIG. 8, the Line-ID is added to only an SIP Message of a predetermined type, and the processing for adding the Line-ID is omitted for an SIP Message to which it is unnecessary to add the Line-ID. Therefore, the processing is made efficient.

FIG. 9 is a flowchart illustrating service information notification processing (F2 of FIG. 5) executed by the SIP Server 3 according to the first embodiment of this invention.

The SIP Server 3 executes processing described below with the transfer of the SDP Answer as an opportunity.

First, the SIP Server 3 determines whether or not the transferred SDP Offer (75) and Answer (76) update an existing Media Flow (271). For example, when a session is established anew, it is determined that the transferred SDP Offer and the like update the existing Media Flow.

When it is determined in Step 271 that the transferred SDP Offer and the like do not update the existing Media Flow, the SIP Server 3 finishes the processing.

On the other hand, when it is determined in Step 271 that the transferred SDP Offer and the like update the existing Media Flow, the SIP Server 3 extracts IDs of terminals (Terminal-IDs) related to the Session from the SIP Session Table (FIG. 2B) (272). In this embodiment, the From URI (72a) and the To URI (73a) illustrated in FIG. 2B are extracted as the Terminal-IDs. Alternatively, other IDs associated with the From URI (72a) and the To URI (73a) may be used.

Next, the SIP Server 3 performs processing of a loop (273 to 279) for the respective Terminal-IDs (specifically, Terminal-IDs on the calling side and the called side) extracted in Step 272.

First, the SIP Server 3 determines whether or not the Terminal-IDs are those of terminals accommodated in the fixed access network 16 (274). In this embodiment, for example, when the Line-ID (72b or 73b) of the SIP Session Table (FIG. 2B) is present, it is determined that the Terminal-IDs as the target of determination are those of terminals accommodated in the fixed access network 16. However, the determination in Step 274 may be executed by another method.

When it is determined in Step 274 that the Line-ID is not present, the SIP Server 3 skips the processing of 275 to 278.

On the other hand, when it is determined in Step 274 that the Line-ID is present, the SIP Server 3 acquires a value of the Line-ID (72b or 73b) (275).

Next, the SIP Server 3 generates a Session-ID for uniquely identifying the SIP Session (276). In this embodiment, the SIP Dialog ID 71 of the SIP Session Table (FIG. 2B) is used as the Session-ID.

Next, the SIP Server 3 extracts a Flow Filter (specifically, Src IP, Dst IP, Protocol, Src Port, and Dst Port) and a bandwidth related to the Session from the SDP Offer (75) and the SDP Answer (76) of FIG. 2B (277).

Finally, the SIP Server 3 notifies the QoS Policy Server 5 of service information (278). The Terminal-ID, the Line-ID acquired in Step 275, the Session-ID generated in Step 276, and the Flow Filter and the bandwidth extracted in Step 277 are included in the service information.

FIG. 10 is a flowchart illustrating Flow registration/RSVP Resv transmission processing (F3 of FIG. 5) executed by the HGW 11 according to the first embodiment of this invention.

The HGW 11 executes processing described below with the transfer of the SDP Answer as an opportunity.

First, the HGW 11 determines whether or not the transferred SDP Offer (155) and Answer (156) update an existing Media Flow (291).

When it is determined in Step 291 that the transferred SDP Offer and the like do not update the existing Media Flow, the HGW 11 finishes the processing.

On the other hand, when it is determined in Step 291 that the transferred SDP Offer and the like update the existing Media Flow, the HGW 11 extracts IDs of terminals (Terminal-IDs) related to the Session from the SIP Session Table (FIG. 4B) (292). In this embodiment, the From URI (152) and the To URI (153) of FIG. 4B are extracted as the Terminal-IDs. Alternatively, other IDs associated with the From URI (152) and the To URI (153) may be used.

Next, the HGW 11 performs processing of a loop 1 (293 to 300) for the respective Terminal-IDs extracted in Step 292. First, the HGW 11 determines whether or not the terminals indicated by the Terminal-IDs are connected to the home network 17 (294). This determination is executed based on a reception port, a terminal IP Address, and the like of the SIP message.

When it is determined in Step 294 that the terminals are not connected to the home network 17, the HGW 11 skips processing of Steps 295 to 299.

On the other hand, when it is determined that the terminals are connected to the home network 17, the HGW 11 sets a flow established by the SDP Offer (155) and the Answer (156) in the Flow Table (FIG. 4C) (295).

Next, the HGW 11 performs processing of a loop 2 (296 to 299) for the respective Flows set in Step 295. First, the HGW 11 determines whether or not the Flows pass through the fixed access network 16 (297). This determination is executed based on transmission source/destination IP addresses of the Flows (172a and 172b of FIG. 4C).

When it is determined in Step 297 that the Flows do not pass through the fixed access network 16, the Flows are closed in the home network 17. In this case, it is unnecessary to transmit a QoS setting request to the AGW 7, and hence the HGW 11 skips processing of Step 298.

On the other hand, when it is determined in Step 297 that the Flows pass through the fixed access network 16, the HGW 11 transmits a QoS setting request (RSVP Resv) to the AGW 7 and sets an entry corresponding to the transmitted request to the RSVP Session Table (FIG. 4D) (298).

FIG. 11 is a flowchart illustrating RSVP Resv reception processing (F4 of FIG. 5) executed by the HGW 11 according to the first embodiment of this invention.

Processing illustrated in FIG. 11 is executed to associate the RSVP Resv (216) transmitted to the AGW 7 by the HGW 11 and the RSVP Resv (217) received from the UA 12 by the HGW 11.

First, the HGW 11 sets an entry corresponding to the RSVP Resv received from the UA 12 in the RSVP Session Table (FIG. 4D) (311).

Next, the HGW 11 retrieves a Flow corresponding to the entry set in Step 311 from the Flow Table (FIG. 4C) (312). This retrieval is executed by determining whether or not filter information and terminal IDs of the respective entries of the Flow Table (FIG. 4C) and filter information and a terminal ID of the entry set in Step 311 coincide with each other. In the Flow Table (FIG. 4C), the filter information is set in the Flow Filter 172. The terminal IDs are set in the Terminal-ID 171. In the RSVP Session Table (FIG. 4D), the filter information is set in the RSVP Session ID 191 and the Filter Spec 193. The terminal IDs are set in the Policy Data 195.

When the Flow matching the conditions of the retrieval is not present in the Flow Table (FIG. 4C) in Step 312, the UA 12 that transmits the RSVP Resv has not executed a procedure indicated by Steps 211 and 212 of FIG. 5. Such a UA 12 is likely to be a malicious terminal. In this case, the HGW 11 deletes the entry set in Step 311, transmits an error response (RSVP ResvErr), and finishes the processing (313).

On the other hand, when the Flow matching the conditions of the retrieval is present in Step 312, the HGW 11 sets 175b of FIG. 4C and 197 of FIG. 4D to thereby create a reciprocal link in the RSVP Session set in Step 311 and the Flow retrieved in Step 312 (314). The RSVP Resv 216 and the RSVP Resv 217 transmitted for the same flow (or the same session) are indirectly associated by Step 314.

Next, the HGW 11 determines whether or not a success response (i.e., RSVP ResvConf 220 of FIG. 5) to the setting request (175a of FIG. 4C) transmitted to the AGW 7 in relation to the Flow retrieved in Step 312 has been received (315).

When it is determined in Step 315 that the success response has not been received, the QoS setting (bandwidth reservation) in the fixed access network 16 has not been finished. In this case, the HGW 11 finishes the processing without further processing.

On the other hand, when it is determined that the success response has been received, the QoS setting (bandwidth reservation) in the fixed access network 16 has been finished. In this case, the HGW 11 returns a success response (RSVP ResvConf 221) to the RSVP Resv 217 received from the UA 12 to the UA 12, sets a state of the entry set in Step 311 to “success response transmitted”, and finishes the processing (316).

The HGW 11 may execute the bandwidth reservation between the UA 12 and the HGW 11 according to the RSVP Resv 217 at any point from Steps 312 to 315.

The RSVP Resv 216 of FIG. 5 is a request for reserving a bandwidth between the HGW 11 and the AGW 7 in the fixed access network 16. The RSVP ResvConf 220 is a success response to the RSVP Resv 216. On the other hand, the RSVP Resv 217 is a request for reserving a bandwidth between the UA 12 and the HGW 11. The RSVP ResvConf 221 is a success response to the RSVP Resv 217. Any one of those kinds of processing for bandwidth reservation responding to those two requests (216 and 217) may be executed earlier. Therefore, originally, after the processing of Step 314 is finished, the HGW 11 can transmit the RSVP ResvConf 221 to the UA 12 even if the RSVP ResvConf 220 has not been received.

However, when the UA 12 receives the RSVP ResvConf 221, the UA 12 executes the processing of Step 222 and subsequent steps of FIG. 5. The processing of Step 222 and subsequent steps need to be executed after the bandwidth reservation between the HGW 11 and the AGW 7 is finished (i.e., after the processing of F5 is finished). Therefore, the HGW 11 according to this embodiment transmits the RSVP ResvConf 221 only after the RSVP ResvConf 220 is received (315 and 316). As a result, the UA 12 is prevented from executing the processing of Step 222 and subsequent steps before the bandwidth reservation between the HGW 11 and the AGW 7 is finished.

FIG. 12 is a flowchart illustrating Flow permission processing (F5 of FIG. 5) executed by the QoS Policy Server 5 according to the first embodiment of this invention.

When the QoS Policy Server 5 receives a QoS permission request from the AGW 7, the QoS Policy Server 5 executes processing described below (see F5 of FIG. 5).

First, the QoS Policy Server 5 sets an entry corresponding to the received QoS permission request in the Flow Table (FIG. 3C) (331).

Next, the QoS Policy Server 5 retrieves service information corresponding to the entry set in Step 331 from the Service Information Table (FIG. 3B) (332). The retrieval of the service information is executed by determining whether or not filter information of a Flow, line IDs, and terminal IDs which are set in the respective entries of the Service Information Table (FIG. 3B) and filer information, a line ID, and a terminal ID of the entry set in Step 331 coincide with each other.

In the Service Information Table (FIG. 3B), the filter information is set in the Flow Filter 94. The line IDs are set in the Line-ID 92. The terminal IDs are set in the Terminal-ID 93. In the Flow Table (FIG. 3C), the filter information is set in the Flow Filter 113. The line IDs are set in the Line-ID 111. The terminal IDs are set in the Terminal-ID 112.

When the service information matching the conditions of the retrieval is not present in Step 332, the QoS Policy Server 5 deletes the entry set in Step 331, transmits an error response to the AGW 7 (333), and finishes the processing.

On the other hand, when the service information matching the conditions of the retrieval is present in Step 332, the QoS Policy Server 5 determines whether or not the requested bandwidth (114) exceeds the bandwidth (95) of the service information retrieved in Step 332 (i.e., service information matching the conditions of the retrieval) (334).

When the requested bandwidth (114) exceeds the bandwidth (95) of the service information in Step 334, the QoS Policy Server 5 executes the error processing in Step 333 and finishes the processing.

On the other hand, when the requested bandwidth (114) does not exceed the bandwidth (95) of the service information in Step 334, the QoS Policy Server 5 retrieves line information from the Line Table (FIG. 3D) based on the Line-ID (111) included in the QoS permission request (335). Specifically, the QoS Policy Server 5 retrieves, from the Line Table (FIG. 3D), an entry in which the same value as the Line-ID (111) included in the received QoS permission request is registered as the Line-ID (131).

Next, the QoS Policy Server 5 determines whether or not a sum of the current bandwidth (136) of the entry retrieved in Step 335 and the requested bandwidth (114) exceeds the maximum guaranteed bandwidth (135) (336).

When it is determined in Step 336 that the sum of the current bandwidth (136) and the requested bandwidth (114) exceeds the maximum guaranteed bandwidth (135), the QoS Policy Server 5 executes the error processing in Step 333 and finishes the processing.

On the other hand, when it is determined in Step 336 that the sum of the current bandwidth (136) and the requested bandwidth (114) does not exceed the maximum guaranteed bandwidth (135), the QoS Policy Server 5 determines whether or not the sum of the current bandwidth (136) of the entry retrieved in Step 335 and the requested bandwidth (114) exceeds the minimum guaranteed bandwidth (134) (337).

When it is determined in Step 337 that the sum of the current bandwidth (136) and the requested bandwidth (114) does not exceed the minimum guaranteed bandwidth (134), the QoS Policy Server 5 skips the processing of Step 338.

On the other hand, when it is determined in Step 337 that the sum of the current bandwidth (136) and the requested bandwidth (114) exceeds the minimum guaranteed bandwidth (134), the QoS Policy Server 5 increases the guaranteed bandwidth of PON to the sum of the current bandwidth (136) of the entry retrieved in Step 335 and the requested bandwidth (114) (338).

Finally, the QoS Policy Server 5 adds the requested bandwidth (114) to the current bandwidth (136) of the entry retrieved in Step 335, transmits a success response to the AGW 7, and finishes the processing (339).

According to the above-mentioned processing of FIG. 12, a QoS is controlled based on a bandwidth requested in a session associated with the same Line-ID. The session associated with the same Line-ID is a session that passes through the same HGW 11 (i.e., session that uses the same line in the fixed access network 16).

In other words, when a plurality of Flows that use the same line are present, a total value of bandwidths requested in all the Flows is calculated (336 and 337). The calculated total value is set as a guaranteed bandwidth in the fixed access network 16 (339). However, when the calculated total value exceeds the maximum guaranteed bandwidth, the guaranteed bandwidth in the fixed access network 16 is not changed and an error is responded (333). When the calculated total value does not exceed the minimum guaranteed bandwidth, the minimum guaranteed bandwidth is set as a guaranteed bandwidth in the fixed access network 16.

FIG. 13 is a flowchart illustrating RSVP ResvConf reception processing (F6 of FIG. 5) executed by the HGW 11 according to the first embodiment of this invention.

First, the HGW 11 retrieves an entry corresponding to the received ResvConf 220 from the RSVP Session Table (FIG. 4D) (351).

When the entry matching the conditions of the retrieval is not present in Step 351, the HGW 11 finishes the processing.

On the other hand, when the entry matching the conditions of the retrieval is present in Step 351, the HGW 11 updates the state (196) of the retrieved entry to “success response received” (352).

Next, the HGW 11 determines whether or not the Flow (197) associated with the entry retrieved in Step 351 has received the RSVP Resv 217 from the terminal (UA 12) (353). Specifically, when the From Terminal 175b of the Flow Table (FIG. 4C) is set, it is determined that the RSVP Resv 217 has been received.

When it is determined in Step 353 that the RSVP Resv 217 is not received yet, the HGW 11 finishes the step processing.

On the other hand, when it is determined in Step 353 that the RSVP Resv 217 has been received, the HGW 11 determines whether or not the response 221 to the RSVP Resv 217 has already been transmitted (354).

As described with reference to FIG. 11, after the execution of the processing of Step 314 of FIG. 11 has been finished and the RSVP ResvConf 220 has been received, the HGW 11 may transmit the RSVP ResvConf 221 before executing the processing illustrated in FIG. 13. Therefore, the RSVP ResvConf 221 may have already been transmitted before Step 354 is executed.

When it is determined in Step 354 that the response has already been transmitted, the HGW 11 finishes the processing.

On the other hand, when it is determined in Step 354 that the response is not transmitted yet, the HGW 11 transmits a success response (RSVP ResvConf 221) to the terminal, updates the state (196) set in Step 353 to “success response transmitted”, and finishes the processing (355).

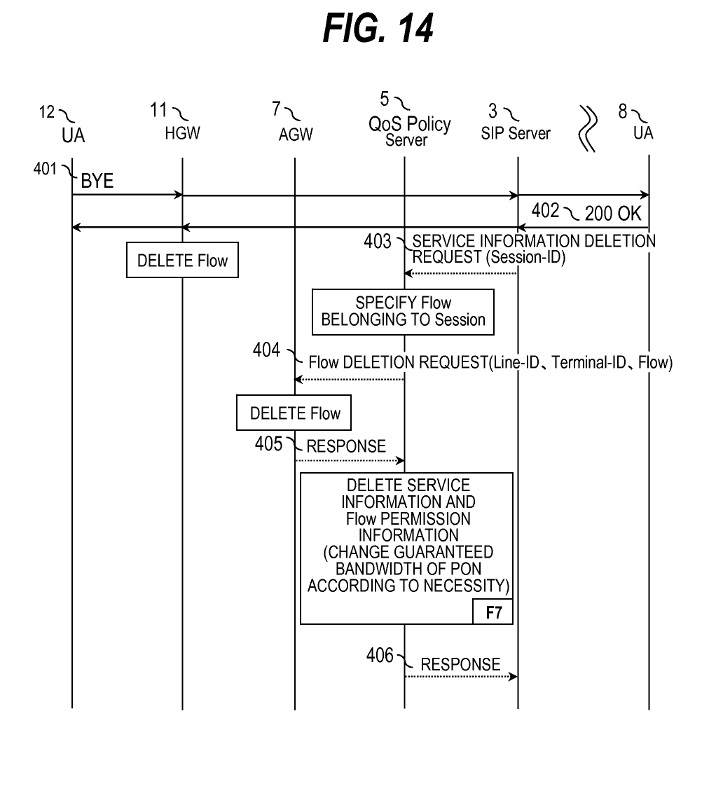

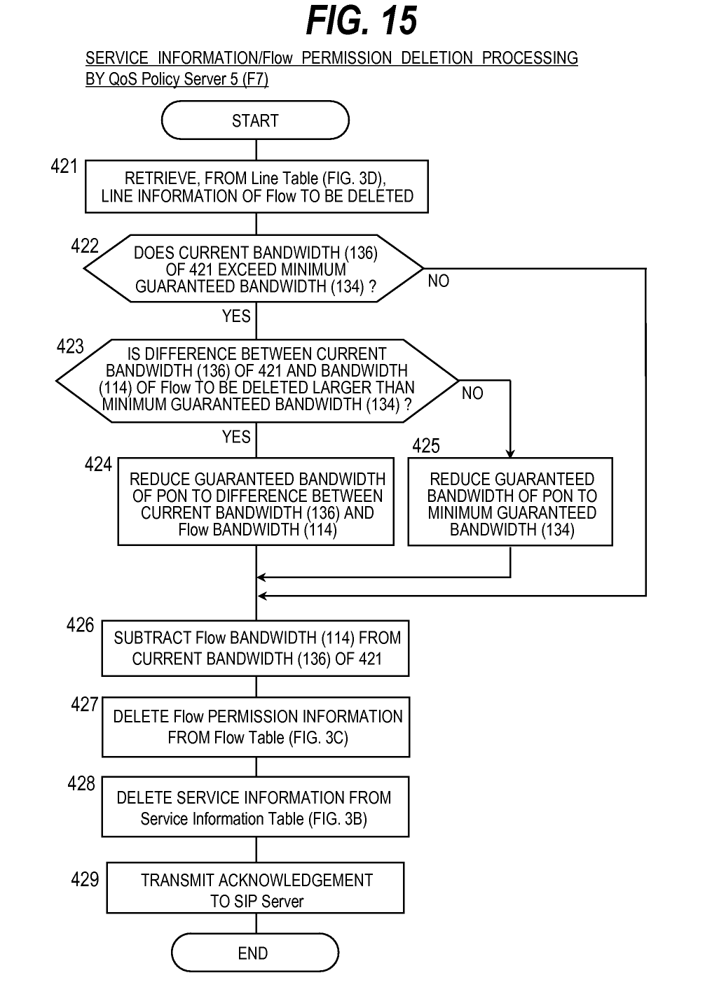

FIG. 14 is a sequence chart illustrating processing for session disconnection according to the first embodiment of this invention.

FIG. 14 illustrates, as an example, a sequence for disconnecting the session established by the processing illustrated in FIG. 5.

First, the terminal (UA 12) transmits an SIP BYE 401 to the terminal (UA 8). The BYE 401 reaches the terminal (UA 8) through the HGW 11, the SIP Server 3, the SIP Server 1, and the SIP Server 2.

The terminal (UA 8) transmits a 200 response 402 to the BYE 401. The 200 response 402 reaches the terminal (UA 12) through a path opposite to that for the BYE.

The HGW 11 deletes an entry corresponding to the session, which is disconnected by the HGW 11, from the SIP Session Table (FIG. 4B), the Flow Table (FIG. 4C), and the RSVP Session Table (FIG. 4D) with the transfer of the BYE 401 as an opportunity.

The SIP Server 3 transmits a service information deletion request 403 to the QoS Policy Server 5 with the transfer of the BYE 401 as an opportunity. A Session-ID for identifying an SIP Session is included in the service information deletion request 403.

The QoS Policy Server 5 retrieves a Flow belonging to the Session in response to the service information deletion request 403 and transmits a Flow deletion request 404 to the AGW 7. The Flow deletion request 404 designates a Line-ID, a Terminal-ID, and a Flow Filter.

The AGW 7 deletes the Flow designated by the Flow deletion request 404 from the local table (not shown) and returns an acknowledgment 405.

The QoS Policy Server 5 deletes the service information and the Flow permission information from the Service Information Table (FIG. 3B) and the Flow Table (FIG. 3C). Further, the QoS Policy Server 5 transmits an acknowledgement 406 to the SIP Server 3 (F7). In F7, the QoS Policy Server 5 controls the line guaranteed bandwidth of PON according to necessity.

FIG. 15 is a flowchart illustrating service information/Flow permission deletion processing (F7 of FIG. 14) executed by the QoS Policy Server 5 according to the first embodiment of this invention.

First, the QoS Policy Server 5 retrieves line information of the Flow, which is deleted by the QoS Policy Server 5, from the Line Table (FIG. 3D) (421).

Next, the QoS Policy Server 5 determines whether or not the current bandwidth (136) included in the line information retrieved in Step 421 exceeds the minimum guaranteed bandwidth (134) (422).

When it is determined in Step 422 that the current bandwidth (136) does not exceed the minimum guaranteed bandwidth (134), the QoS Policy Server 5 skips processing of Steps 423 to 425.

On the other hand, when it is determined in Step 422 that the current bandwidth (136) exceeds the minimum guaranteed bandwidth (134), the QoS Policy Server 5 determines whether or not a difference between the current bandwidth (136) retrieved in Step 421 and the bandwidth (114) of the Flow, which is deleted by the QoS Policy Server 5, is larger than the minimum guaranteed bandwidth (134) (423).

When it is determined in Step 423 that the calculated difference is larger than the minimum guaranteed bandwidth (134), the QoS Policy Server 5 reduces the guaranteed bandwidth of PON to the difference between the current bandwidth (136) and the Flow bandwidth (114) (424).

On the other hand, when it is determined in Step 423 that the calculated difference is smaller than the minimum guaranteed bandwidth (134), the QoS Policy Server 5 reduces the guaranteed bandwidth of PON to the minimum guaranteed bandwidth (134) (425).

Next, the QoS Policy Server 5 subtracts the Flow bandwidth (114) from the current bandwidth (136) retrieved in Step 421 (426).

Next, the QoS Policy Server 5 deletes the Flow permission information from the Flow Table (FIG. 3C) (427).

Next, the QoS Policy Server 5 deletes the service information from the Service Information Table (FIG. 3D) (428).

Finally, the QoS Policy Server 5 transmits an acknowledgement to the SIP Server (429) and finishes the processing.

As described above, according to the first embodiment of this invention, the HGW 11 transmits an SIP message including an identifier of a line (Line-ID) to the service network 14. As a result, it is possible to control a QoS in line units. Further, according to the first embodiment, the HGW 11 transmits, on behalf of the terminal, the QoS setting request to the AGW 7. As a result, only an apparatus having a relationship of trust with a communication carrier can control the QoS setting.

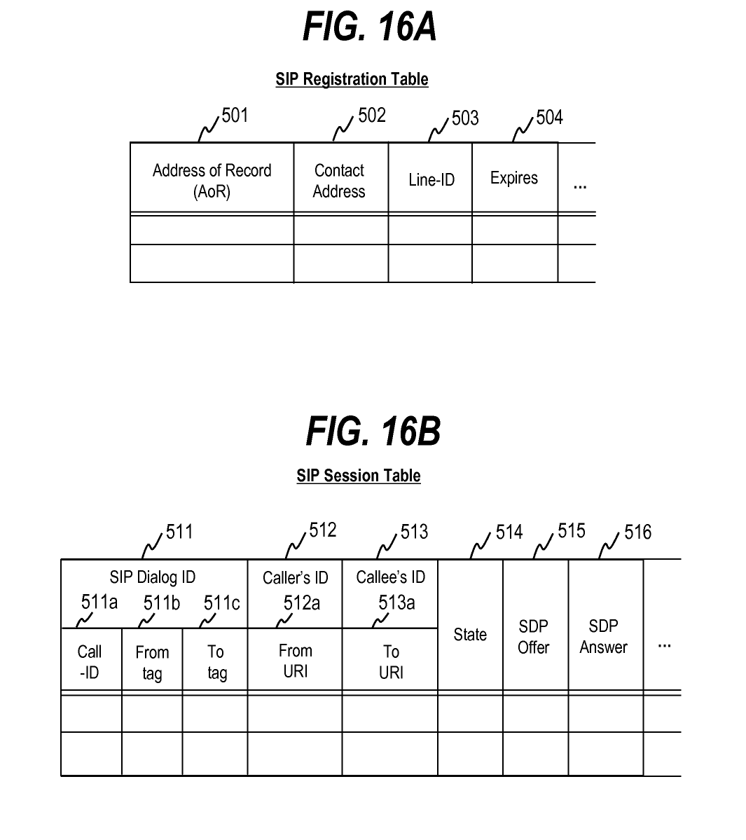

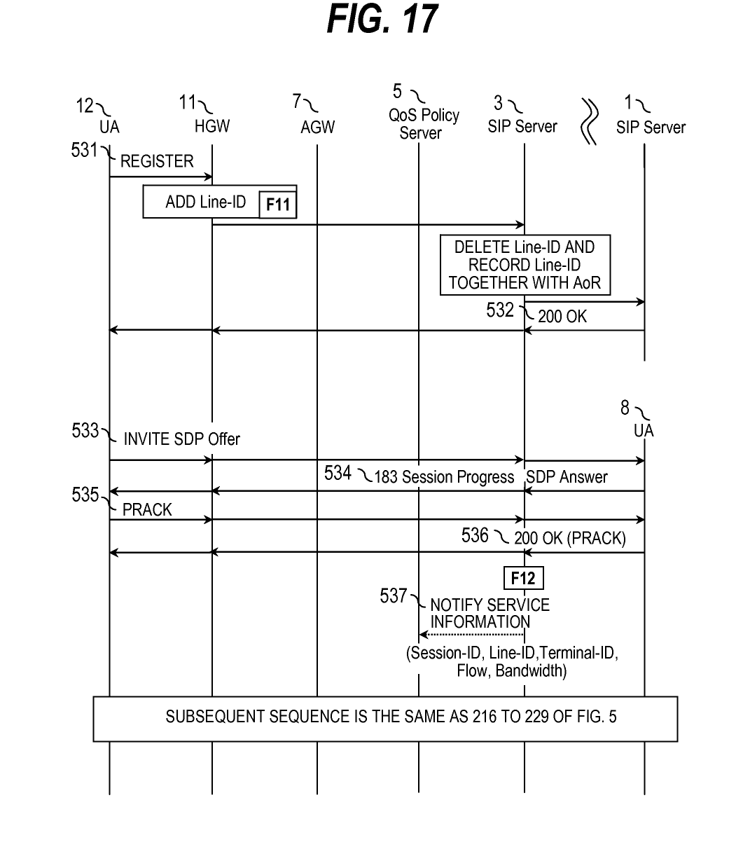

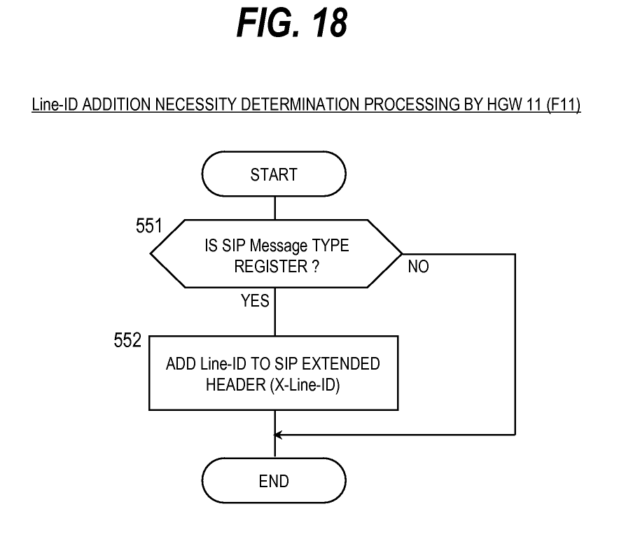

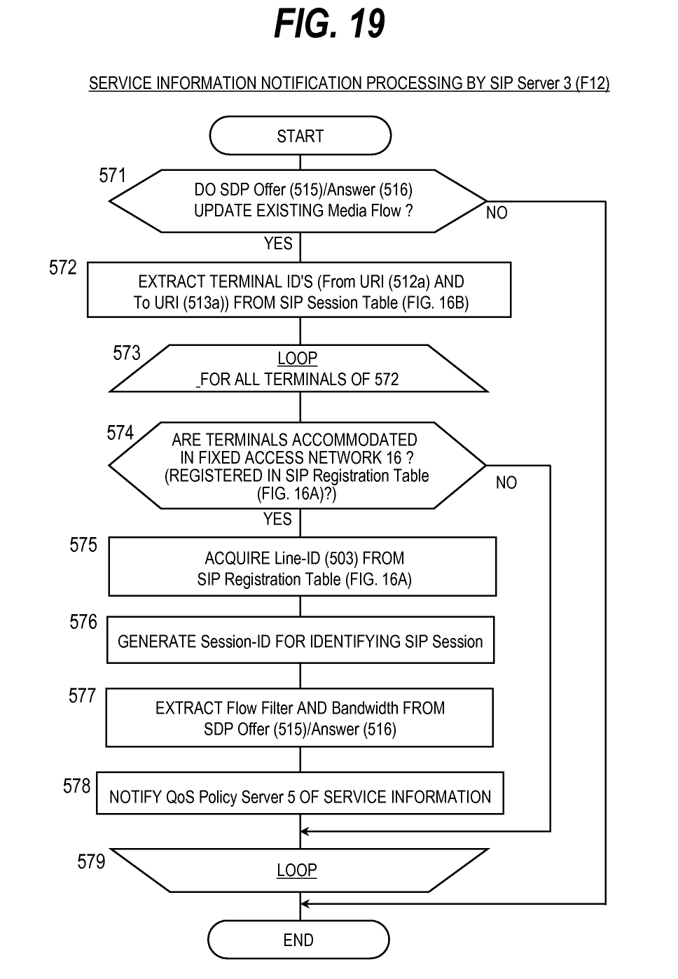

Next, referring to FIGS. 16A to 18, a second embodiment of this invention will be described. A configuration of a communication network according to the second embodiment is the same as that according to the first embodiment (FIG. 1). In the first embodiment, the HGW 11 adds the line ID to the SIP message including the SDP Offer/Answer. On the other hand, the second embodiment is different from the first embodiment in that a line ID is added to an SIP REGISTER, which is a message for registering a position of a terminal. Therefore, according to the second embodiment, if the line ID is registered once at the time of first position registration, it is possible to continuously use the information after that.

In the second embodiment, the SIP Server 3 includes a Registration Table illustrated in FIG. 16A and an SIP Session Table illustrated in FIG. 16B.

FIG. 16A is an explanatory diagram of the Registration Table stored by the SIP server 3 according to the second embodiment of this invention.

The Registration Table (FIG. 16A) is used for managing registration information of terminals. The Registration Table (FIG. 16A) includes an Address of Record (AoR) 501 indicating a public address of a terminal, a Contact Address 502 indicating a communication address of the terminal, a Line-ID 503 for identifying a line, and an Expires 504 indicating a term of validity of registration.

FIG. 16B is an explanatory diagram of the SIP Session Table stored by the SIP Server 3 according to the second embodiment of this invention.

The SIP Session Table (FIG. 16B) is used for managing an SIP Session state. The SIP Session Table (FIG. 16B) includes an SIP Dialog ID 511 for uniquely identifying an SIP Session, a Caller's ID 512 for identifying a calling terminal, a Callee's ID 513 for identifying a called terminal, a State 514 indicating a Session state, an SDP Offer 515, and an SDP Answer 516.

The SIP Dialog ID 511 includes a Call-ID 511a, a From tag 511b, and a To tag 511c.

The Caller's ID 512 includes a From URI 512a.

The Callee's ID 513 includes a To URI 513a.

Unlike the SIP Session Table (FIG. 2B) according to the first embodiment, the Caller's ID 512 and the Callee's ID 513 do not include a Line-ID.

FIG. 17 is a sequence chart illustrating processing for session establishment according to the second embodiment of this invention.

In FIG. 17, the terminal (UA 12) connected to the home network 17 applies position registration to the SIP Servers (1 and 3). A session is established between the terminal (UA 12) and the terminal (UA 8). Details of a sequence illustrated in FIG. 17 will be described below.

First, the terminal (UA 12) transmits an SIP REGISTER 531.

The HGW 11 adds a Line-ID to the REGISTER 531 and transfers the REGISTER 531 to the SIP Server 3 (F11).

The SIP Server 3 deletes the Line-ID from the REGISTER 531 and records the deleted Line-ID in the Registration Table (FIG. 16A) together with AoRs of the terminals. The SIP Server 3 transfers the REGISTER 531 to the SIP Server 1.

The SIP Server 1 returns a 200 response 532 to the REGISTER 531. The 200 response 532 reaches the terminal (UA 12) through a path opposite to that of the REGISTER 531.

Next, the terminal (UA 12) transmits an SIP INVITE 533 including an SDP Offer. The INVITE 533 reaches the terminal (UA 8) through the HGW 11, the SIP Server 3, the SIP Server 1, and the SIP Server 2.

The terminal (UA 8) returns a 183 response 534 including an SDP Answer.

The terminal (UA 12) returns a PRACK 535 to the 183 response 534.

The terminal (UA 8) returns a 200 response 536 to the PRACK 535.

The SIP Server 3 notifies the QoS Policy Server 5 of service information 537 with the transfer of the SDP Answer as an opportunity (F12). This notification of the service information 537 may be executed any one of before and after the transmission of the PRACK 535 or may be executed any one of before and after the transmission of the 200 response 536.

The service information notification 537 includes a Session-ID, a Line-ID, a Terminal-ID, a Flow Filter, and a bandwidth.

A subsequent sequence is omitted because the sequence is the same as 216 to 229 of FIG. 5.

Next, referring to FIGS. 18 and 19, processing characteristic of the sequence of FIG. 17 will be described.

FIG. 18 is a flowchart illustrating Line-ID addition determination processing (F11 of FIG. 17) executed by the HGW 11 according to the second embodiment of this invention.

First, the HGW 11 determines whether or not an SIP Message, which is transferred by the HGW 11, is REGISTER (551).

When it is determined in Step 551 that the SIP message, which is transferred by the HGW 11, is not the REGISTER, the HGW 11 finishes the processing.

On the other hand, when it is determined in Step 551 that the SIP message, which is transferred by the HGW 11, is the REGISTER, the HGW 11 adds a Line-ID to the REGISTER (552) and finishes the processing.

According to the execution of the processing of FIG. 18, a line ID is added to only a signal of a predetermined type (in the example of FIG. 18, REGISTER), and thus it is possible to make the processing efficient.

FIG. 19 is a flowchart illustrating service information notification processing (F12 of FIG. 17) executed by the SIP Server 3 according to the second embodiment of this invention.

The processing illustrated in FIG. 19 is different from the service information notification processing (FIG. 9) in the first embodiment as described below.

First, in Step 274 of FIG. 9, the SIP Server 3 determines whether or not a terminal is connected to the fixed access network 16 based on whether or not the Line-ID field (72b or 73b) of the SIP Session Table (FIG. 2B) is set. On the other hand, in Step 574 of FIG. 19, the same determination is executed based on whether or not a terminal is registered in the SIP Registration Table (FIG. 16A).

In Step 275 of FIG. 9, the SIP server 3 acquires a Line-ID from the Line-ID field (72b or 73b) of the SIP Session Table (FIG. 2B). On the other hand, in Step 575 of FIG. 19, a Line-ID is acquired from the Line-ID field (503) of the SIP Registration Table (FIG. 16A).

Except for the differences described above, Steps 571 to 579 of FIG. 19 are the same as Steps 271 to 279 of FIG. 9.

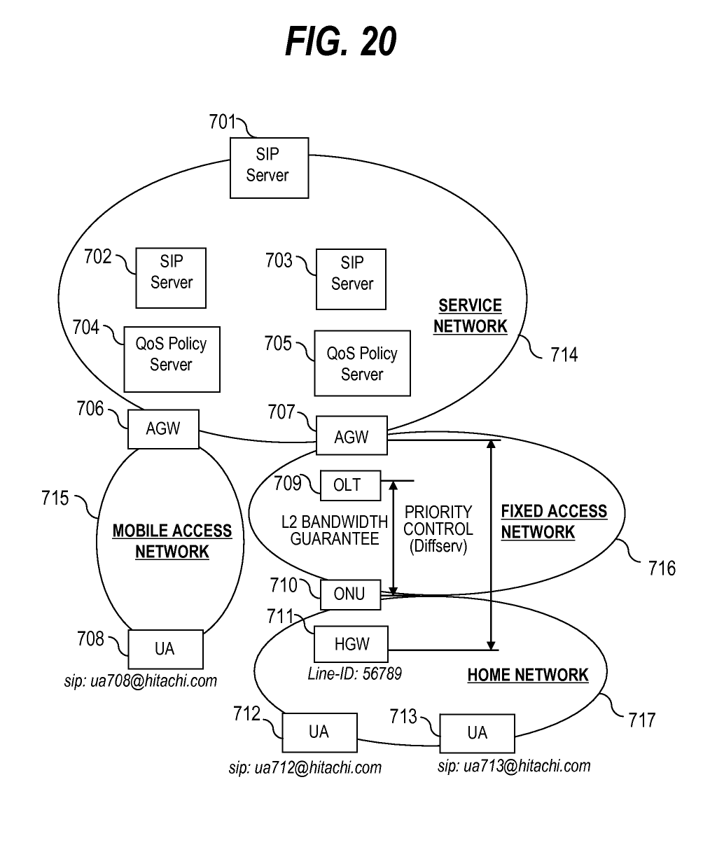

Next, referring to FIGS. 20 to 25, a third embodiment of this invention will be described.

FIG. 20 is an explanatory diagram illustrating a configuration example of a communication network according to the third embodiment of this invention.

In the first and second embodiments, the flow-by-flow bandwidth guarantee based on an Integrated Services (IntServ) model is executed between the AGW 7 of the fixed access network 16 and the HGW 11. On the other hand, in the third embodiment, unlike the first and second embodiments, priority control based on a Differentiated Services (DiffServ) model is executed.

The communication network illustrated in FIG. 20 includes an access-independent service network 714, a mobile access network 715, a fixed access network 716, and a home network 717. As described below, according to the third embodiment, when the priority control based on the DiffServ model is performed, it is possible to perform bandwidth control in line units using information included in a session control signal.

The service network 714 includes SIP Servers (701, 702, and 703), QoS Policy Servers (704 and 705), and AGWs (706 and 707).

The mobile access network 715 includes a UA 708.

The fixed access network 716 includes an OLT 709 and an ONU 710.

The home network 717 includes an HGW 711 and UAs (712 and 713). A line ID (Line-ID: 56789) is set in the HGW 711.

QoS processing described below is executed in the fixed access network 716.

The AGW 707 and the HGW 711 identify a priority flow in a Layer 3 and higher layers and put markings in the TOS field of the IPv4 header and the Traffic Class field of the IPv6 header. Further, the AGW 707 and the HGW 711 performs priority control according to a marking result. Unlike the first and second embodiments, filter information for identifying a priority flow is statically set.

The OLT 709 and the ONU 710 perform bandwidth guarantee for the priority flow at the Layer 2 level. The identification of the priority flow conforms to the marking result by the AGW 701 and the HGW 711. The guaranteed bandwidth is controlled by the QoS Policy Server 705 according to necessity.

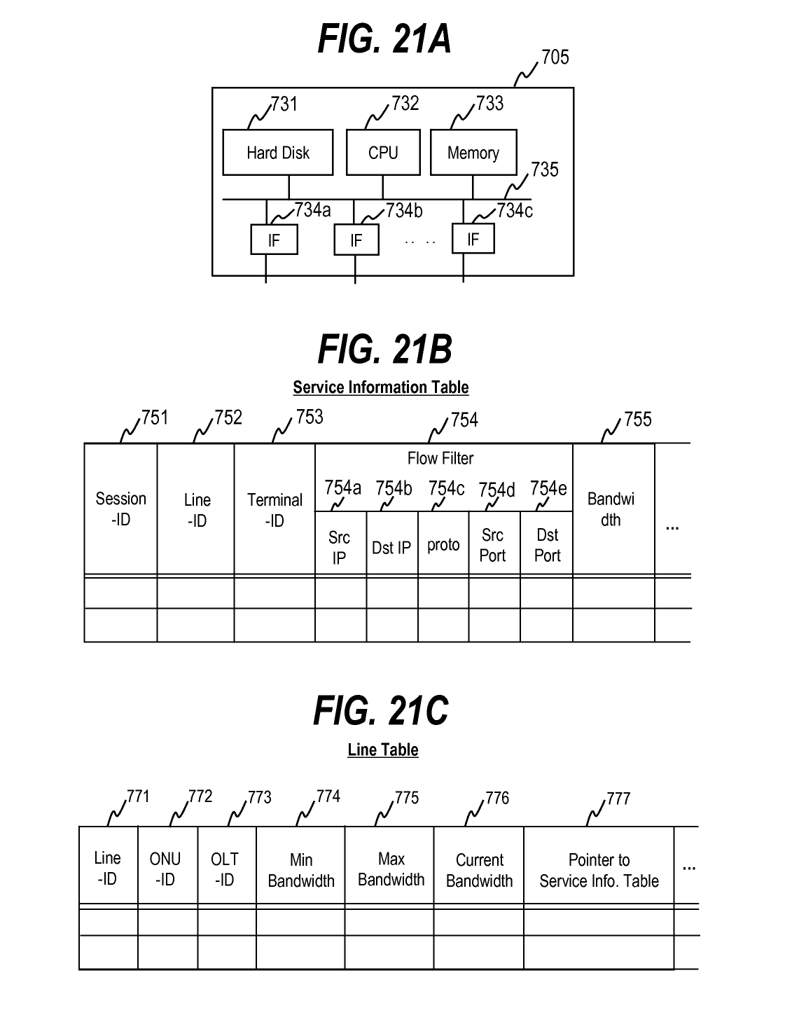

FIG. 21A is a block diagram illustrating a configuration of the QoS Policy Server 705 according to the third embodiment of this invention.

The QoS Policy Server 705 includes a Hard Disk 731, a CPU 732, a Memory 733, IFs (734a, 734b, and 734c), and a bus 735. Processing procedures for the QoS Policy Server 705 are stored in the Memory 733. The CPU 732 sequentially reads out and executes the processing procedures.

The QoS Policy Server 705 stores a Service Information Table illustrated in FIG. 21B and a Line Table illustrated in FIG. 21C.

FIG. 21B is an explanatory diagram of the Service Information Table stored by the QoS Policy Server 705 according to the third embodiment of this invention.

The Service Information Table (FIG. 21B) is a table for managing service information permitted to the SIP Server 703. The Service Information Table (FIG. 21B) includes a Session ID 751 for identifying an SIP Session, a Line-ID 752 for identifying a line, a Terminal-ID 753 for identifying a terminal, a Flow Filter 754 for identifying a flow, and a Bandwidth 755 indicating a bandwidth in use. The Flow Filter 754 includes an Src IP 754a, a Dst IP 754b, a proto 754c, an Src Port 754d, and a Dst Port 754e.

FIG. 21C is an explanatory diagram of the Line table stored by the QoS Policy Server 705 according to the third embodiment of this invention.

The Line Table (FIG. 21C) is a table for managing a bandwidth of a line. The Line Table (FIG. 21C) includes a Line-ID 771 for identifying a line, an ONU-ID 772 for identifying an ONU, an OLT-ID 773 for identifying an OLT, a minimum guaranteed bandwidth Min Bandwidth 774 of the line, a maximum guaranteed bandwidth Max Bandwidth 775, a current bandwidth Current Bandwidth 776, and a Pointer to Service Info. Table 777 as a pointer to service information (FIG. 21B, Service Information Table) for using the line. When a plurality of flows that use the line are present, a plurality of pointers are set in the Pointer to Service Info. Table 777.

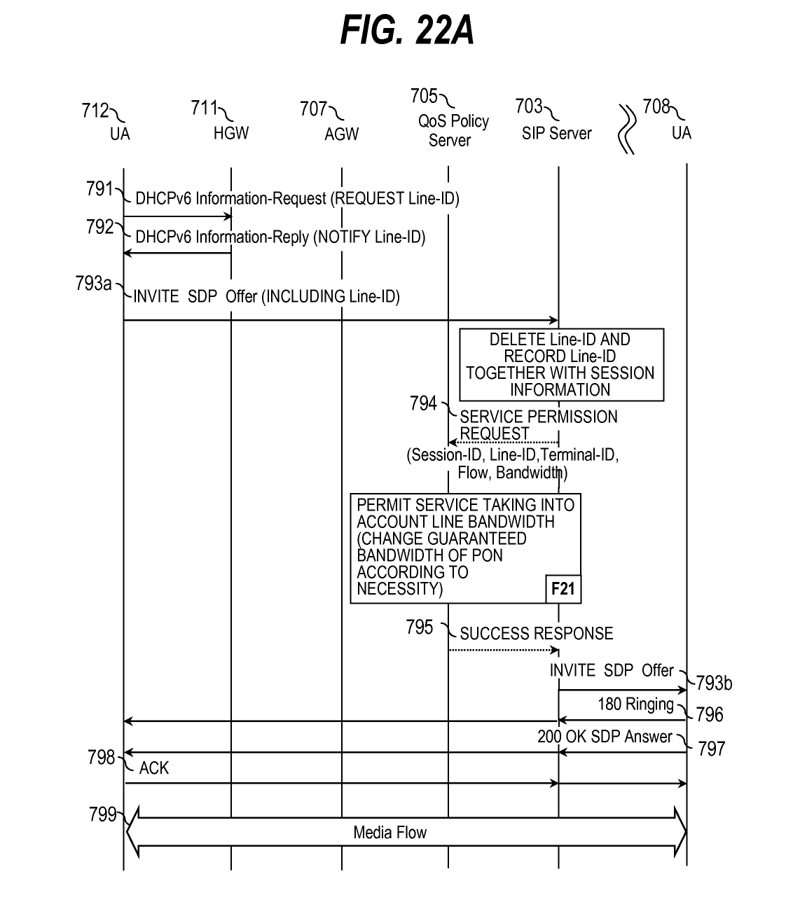

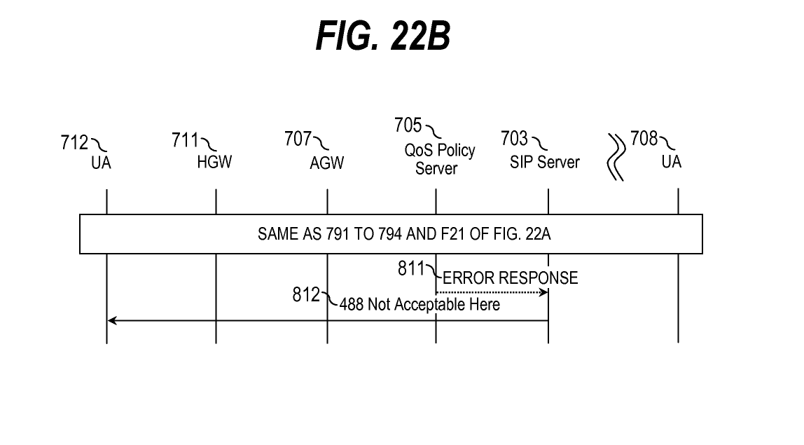

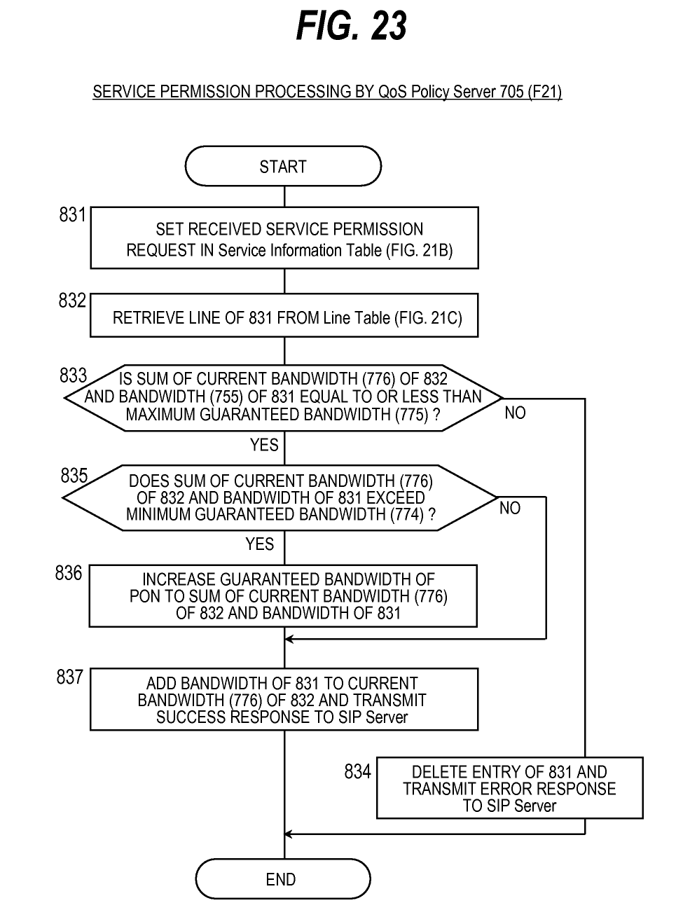

FIGS. 22A and 22B are sequence charts illustrating processing for session establishment according to the third embodiment of this invention.

In FIGS. 22A and 22B, the terminal (UA 712) acquires a line ID from the HGW 711 using DHCPv6. The terminal (UA 712) itself transmits an SIP INVITE including the line ID and establishes a session between the terminal (UA 712) and the terminal (UA 708). Unlike the first and second embodiments, in this sequence, QoS permission is executed simultaneously with service information notification from the SIP Server 703.

Details of FIGS. 22A and 22B will be described below.

In FIG. 22A, first, the terminal (UA 712) transmits a DHCPv6 Information-Request 791 to the HGW 711 and requests a Line-ID. The HGW 711 returns a DHCPv6 Information-Reply 792 and notifies the Line-ID.

Next, the terminal (UA 712) transmits an SIP INVITE 793a to the SIP Server 703. The SIP INVITE 793a includes an SDP Offer and the Line-ID.

Information indicating a bandwidth requested by the terminal (UA 712) in a session about to be established is included in the SIP INVITE 793a.

The SIP Server 703 deletes the Line-ID from the INVITE 793a and records the Line-ID together with the session information. Further, the SIP Server 703 transmits a service permission request 794 to the QoS Policy Server 705. A session-ID, a Line-ID, a Terminal-ID, a Flow Filter, and a bandwidth extracted from an SIP/ SDP Message are included in the service permission request 794. The bandwidth included in the service permission request 794 is a bandwidth requested in a session by a terminal identified by the Terminal-ID.

The QoS Policy Server 705 performs service permission and bandwidth control of PON taking into account a line bandwidth (F21).

When the QoS Policy Server 705 fails in the service permission illustrated in F21, the QoS Policy Server 705 returns an error response 811 illustrated in FIG. 22B. The SIP Server 703 that receives the error response 811 returns a 488 response 812 to the terminal (UA 712) and the session establishment ends in failure.

On the other hand, when the QoS Policy Server 705 succeeds in the service permission illustrated in F21, the QoS Policy Server 705 returns a success response 795 illustrated in FIG. 22A. The SIP Server 703 that receives the success response 795 transfers an INVITE 793b to the terminal (UA 708).

The terminal (UA 708) starts a user call and returns a 180 response 796. Further, the terminal (UA 708) transmits 200 response 797 including an SDP Answer with on-hook by the user as an opportunity.

The terminal (UA 712) returns an ACK 798. As a result, transmission and reception of a Media Flow 799 is started.

In the third embodiment, the UA 712 acquires a Line-ID from the HGW 711 (791 and 792) and transmits the SIP INVITE 793a including the Line-ID to the SIP Server 703. However, as in the first embodiment, the HGW 711 may add a Line-ID to an SIP INVITE (see the SIP INVITE 211 of FIG. 5) received from the UA 712 (see F1 of FIG. 5) and transmits the SIP INVITE to the SIP Server 703.

Conversely, in the first embodiment, as in the third embodiment, the UA 12 may acquire a Line-ID from the HGW 11 and transmit an SIP INVITE including the Line-ID to the SIP Server 3.

FIG. 23 is a flowchart for illustrating service permission processing (F21 of FIG. 22A) executed by the QoS Policy Server 705 according to the third embodiment of this invention.

First, the QoS Policy Server 705 sets an entry corresponding to a received service permission request in the Service Information Table (FIG. 21B) (831).

Next, the QoS Policy Server 705 retrieves line information from the Line Table (FIG. 21C) based on the Line-ID (752) of the service information (832). Specifically, the QoS Policy Server 705 retrieves, from the Line Table (FIG. 21C), an entry in which the same value as the Line-ID (752) included in the received QoS permission request is registered as the Line-ID (771).

Next, the QoS Policy Server 705 determines whether or not a sum of the current bandwidth (776) retrieved in Step 832 and the bandwidth (755) of the service information exceeds the maximum guaranteed bandwidth (775) retrieved in Step 832 (833).

When it is determined in Step 833 that the sum of the current bandwidth (776) and the bandwidth (755) of the service information exceeds the maximum guaranteed bandwidth (775), the QoS Policy Server 705 deletes the entry set in Step 831, transmits the error response 811 illustrated in FIG. 22B to the SIP server, and finishes the processing (834).

On the other hand, when it is determined in Step 833 that the sum of the current bandwidth (776) and the bandwidth (755) of the service information does not exceed the maximum guaranteed bandwidth (775), the QoS Policy Server 705 determines whether or not the sum of the current bandwidth (776) retrieved in Step 832 and the bandwidth (755) of the service information exceeds the minimum guaranteed bandwidth (774) retrieved in Step 832 (835).

When it is determined in Step 833 that the sum of the current bandwidth (776) and the bandwidth (755) of the service information exceeds the minimum guaranteed bandwidth (774), the QoS Policy Server 705 increases the guaranteed bandwidth of PON to the sum of the current bandwidth (776) retrieved in Step 832 and the bandwidth (755) of the service information (836).

On the other hand, when it is determined in Step 833 that the sum of the current bandwidth (776) and the bandwidth (755) of the service information does not exceed the minimum guaranteed bandwidth (774), the QoS Policy Server 705 skips processing of Step 836.

Finally, the QoS Policy Server 705 adds the bandwidth (755) of the service information to the current bandwidth (776) retrieved in Step 832, transmits the success response 795 illustrated in FIG. 22A to the SIP server, and finishes the processing.

Like the processing of FIG. 12 in the first embodiment, according to the above-mentioned processing of FIG. 23, a QoS is controlled based on a bandwidth requested in a session associated with the same Line-ID. The session associated with the same Line-ID is a session that passes through the same HGW 711 (i.e., session that uses the same line in the fixed access network 716).

In other words, when a plurality of Flows that use the same line are present, a total value of bandwidths requested in all the Flows is calculated (833 and 835). The calculated total value is set as a guaranteed bandwidth in the fixed access network 16 (836). However, when the calculated total value exceeds the maximum guaranteed bandwidth, the guaranteed bandwidth in the fixed access network 716 is not changed and an error is responded (834). When the calculated total value does not exceed the minimum guaranteed bandwidth, the minimum guaranteed bandwidth is set as a guaranteed bandwidth in the fixed access network 16.

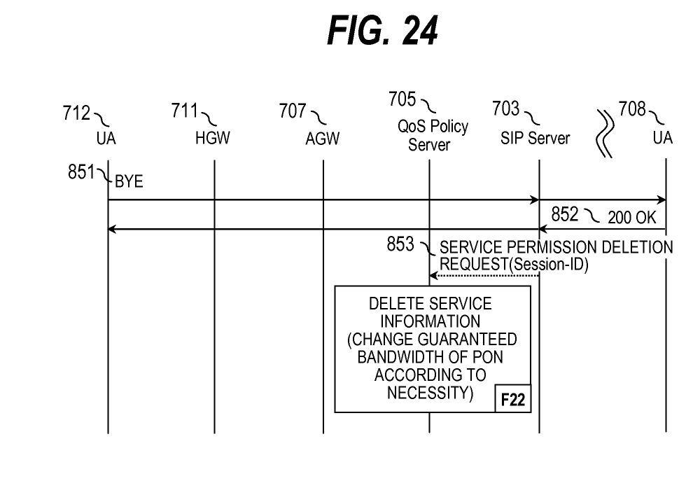

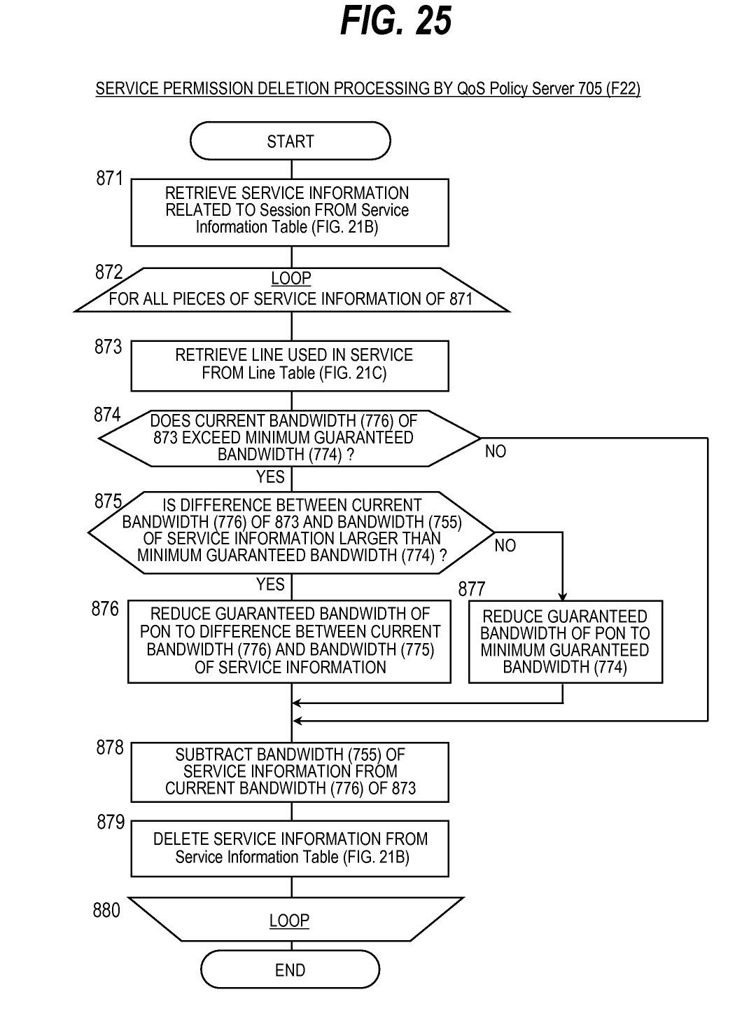

FIG. 24 is a sequence chart illustrating processing executed for session disconnection according to the third embodiment of this invention.

In this sequence, first, the terminal (UA 712) transmits a BYE 851. The terminal (UA 708) that receives the BYE 851 returns a 200 response 852.

The SIP Server 703 transmits a service permission deletion request 853 to the QoS Policy Server 705 with the transfer of the BYE 851 as an opportunity. This request may be transmitted earlier than the 200 response 852. The service permission deletion request 853 includes a Session-ID for identifying a Session.

The QoS Policy Server 705 deletes service information corresponding to the Session-ID and controls a guaranteed bandwidth of PON (F22).

FIG. 25 is a flowchart for illustrating service permission deletion processing (F22 of FIG. 24) executed by the QoS Policy Server 705 according to the third embodiment of this invention.

First, the QoS Policy Server 705 retrieves service information related to a designated Session-ID from the Service Information Table (FIG. 21B) (871).

Next, the QoS Policy Server 705 executes processing of a loop (872 to 880) for all pieces of service information retrieved in Step 871.

First, the QoS Policy Server 705 retrieves line information from the Line Table (FIG. 21C) using the Line-ID (752) of the Service Information Table (FIG. 21B) (873).

Next, the QoS Policy Server 705 determines whether or not the current bandwidth (776) retrieved in Step 873 exceeds the minimum guaranteed bandwidth (774) (874).

When it is determined in Step 874 that the current bandwidth (776) does not exceed the minimum guaranteed bandwidth (774), the QoS Policy Server 705 skips processing of Steps 875 to 877.

On the other hand, when it is determined in Step 874 that the current bandwidth (776) exceeds the minimum guaranteed bandwidth (774), the QoS Policy Server 705 determines whether or not a difference between the current bandwidth (776) retrieved in Step 873 and the bandwidth (755) of the service information is larger than the minimum guaranteed bandwidth (774) (875).

When it is determined in Step 875 that the difference between the current bandwidth (776) and the bandwidth (755) of the service information is larger than the minimum guaranteed bandwidth (774), the QoS Policy Server 705 reduces the guaranteed bandwidth of PON to the difference between the current bandwidth (776) and the bandwidth (755) of the service information (876).

On the other hand, when it is determined that the difference between the current bandwidth (776) and the bandwidth (755) of the service information is equal to or smaller than the minimum guaranteed bandwidth (774), the QoS Policy Server 705 reduces the guaranteed bandwidth of PON to the minimum guaranteed bandwidth (774) (877).

Next, the QoS Policy Server 705 subtracts the bandwidth (755) of the service information from the current bandwidth (776) retrieved in Step 873 (878).

Next, the QoS Policy Server 705 deletes the service information from the Service Information Table (FIG. 21B) (879).

The QoS Policy Server 705 finishes the processing illustrated in FIG. 25.

1. A communication system, comprising:
a plurality of terminals connected to a communication network via an access line;
a session control server that processes a session control signal
transmitted from the terminals; and
a QoS control server that controls a QoS of the access line, wherein:
the terminals transmit at least the session control signal containing information indicating a bandwidth requested by the terminals in a session to the session control server;
the terminals further transmit an identifier of the access line to the session control server;
the session control server transmits the received identifier of the access line and the information indicating the bandwidth requested by the terminals in the session to the QoS control server; and
the QoS control server controls the QoS based on a bandwidth requested in a session associated with the same identifier of the access line.

2. The communication system according to claim 1, wherein the identifier of the access line is contained in the session control signal.

3. The communication system according to claim 1, further comprising a terminal accommodating apparatus that connects the terminals to the access line,
wherein, instead of the terminals transmitting the identifier of the access line, the terminal accommodating apparatus adds the identifier of the access line to the session control signal and transmits the session control signal added with the identifier of the access line to the session control server.

4. The communication system according to claim 1, wherein:
the session control signal is a signal conforming to an SIP; and
the identifier of the access line is set in an SIP header.

5. The communication system according to claim 1, wherein:
the session control signal contains a signal conforming to an SIP and a signal conforming to an SDP; and
the identifier of the access line is set in an SDP attribute row.

6. The communication system according to claim 1, wherein, in a case where the session control signal is a signal of a predetermined type, the identifier of the access line is added to the session control signal.

7. The communication system according to claim 3, wherein:
the terminal accommodating apparatus transmits a first QoS control signal generated based on the received session control signal and the received identifier of the access line to the QoS control server; and
when the QoS control server receives the first QoS control signal, the QoS control server controls the QoS of the access line based on the received first QoS control signal.

8. The communication system according to claim 7, wherein the terminal accommodating apparatus is configured to:
associate, based on the session control signal, the first QoS control signal and a second QoS control signal for controlling a QoS between the terminals and the terminal accommodating apparatus; and
transmit, after receiving a response to the first QoS control signal, a response to the second QoS control signal associated with the received first QoS control signal to the terminals.

9. A communication control apparatus that controls communication in a communication system,
the communication system comprising:
a plurality of terminals connected to a communication network via an access line;
the communication control apparatus that connects at least one of the terminals to the access line;
a session control server that processes a session control signal transmitted from the terminals; and
a QoS control server that controls a QoS of the access line,
the communication control apparatus being configured to:
receive the session control signal from the terminals;
add an identifier of the access line to the received session control signal;
transmit the session control signal added with the identifier of the access line to the session control server;
generate, based on a bandwidth requested by the terminals in a session and the identifier of the access line, a first QoS control signal for causing the QoS control server to control the QoS of the access line; and
transmit the generated first QoS control signal to the QoS control server.

10. The communication control apparatus according to claim 9, further being configured to:
associate, based on the session control signal, the first QoS control signal and a second QoS control signal for controlling a QoS between the terminals and the communication control apparatus; and
transmit, after receiving a response to the first QoS control signal, a response to the second QoS control signal associated with the received first QoS control signal to the terminals.

11. A control method for a communication system comprising:
a plurality of terminals connected to a communication network via an access line;
a session control server that processes a session control signal transmitted from the terminals; and
a QoS control server that controls a QoS of the access line,
the control method comprising:
transmitting, by the terminals, at least the session control signal containing information indicating a bandwidth requested by the terminals in a session to the session control server;
further transmitting, by the terminals, an identifier of the access line to the session control server;
transmitting, by the session control server, the received identifier of the access line and the information indicating the bandwidth requested by the terminals in the session to the QoS control server; and
controlling, by the QoS control server, the QoS based on a bandwidth requested in a session associated with the same identifier of the access line.

12. The method according to claim 11, wherein the identifier of the access line is contained in the session control signal.

13. The method according to claim 11, wherein:
the communication system further comprises a terminal accommodating apparatus that connects the terminals to the access line; and
the method further comprises adding, by the terminal accommodating apparatus, instead of transmitting, by the terminals, the identifier of the access line, the identifier of the access line to the session control signal and transmitting the session control signal added with the identifier of the access line to the session control server.
